(19) United States
(12) Patent Application Publication
(10) Pub. No.: US 2026/0166758 A1
(43) Pub. Date: Jun. 18, 2026

(54) ROBOT HAND

(71) Applicant: SAMSUNG ELECTRONICS CO., LTD., Suwon-si (KR)

(72) Inventors: Baeseok LIM, Suwon-si (KR); Heeseung CHOI, Suwon-si (KR); Sungman PARK, Suwon-si (KR)

(73) Assignee: SAMSUNG ELECTRONICS CO., LTD., Suwon-si (KR)

(21) Appl. No.: 19/444,934

(22) Filed: Jan. 9, 2026

Related U.S. Application Data
(63) Continuation of application No. PCT/KR2025/020871, filed on Dec. 5, 2025.

(30) Foreign Application Priority Data
Dec. 12, 2024 (KR) 10-2024-0184672

(51) Int. Cl. B25J 15/10; B25J 9/10; B25J 17/02

(52) U.S. Cl. CPC B25J 15/10; B25J 9/102; B25J 17/025

(57) ABSTRACT

A robot hand includes a plurality of finger modules; and a connector rotatably connecting two adjacent finger modules among the plurality of finger modules, wherein each finger module comprises: a finger including a plurality of joints; a finger motor including a finger motor shaft configured to operate movement of the finger; an arrangement motor disposed parallel to the finger motor and including an arrangement motor shaft; a housing disposed beneath the finger and accommodating the finger motor and the arrangement motor; and an arrangement gear disposed concentrically with the arrangement motor shaft at an upper surface of the housing, and wherein, for the two adjacent finger modules that are connected by the connector, the arrangement gears of each finger module mesh with each other, and based on an operation of the arrangement motor, the finger module corresponding to the operated arrangement motor rotates about the arrangement motor shaft.

### CROSS-REFERENCE TO RELATED APPLICATIONS

This application is a continuation application of International Application No. PCT/KR2025/020871, filed on Dec. 5, 2025, which is based on and claims priority to Korean Patent Application No. 10-2024-0184672, filed on Dec. 12, 2024, in the Korean Intellectual Property Office, the disclosures of which are incorporated by reference herein in their entireties.

### BACKGROUND

### 1. Field

The disclosure relates to a robot hand.

### 2. Description of Related Art

With recent technological advancements, attempts to use humanoid robots in manufacturing sites are spreading.

However, current industrial humanoid robots are equipped with simple hands designed to take objects of simple shapes, so they may only perform simple tasks.

Therefore, in order to apply humanoid robots to manufacturing sites that require handling of various objects, a hand capable of grasping or picking up objects of various shapes is required.

### SUMMARY

According to an aspect of the disclosure, a robot hand includes: a plurality of finger modules; and a connector rotatably connecting two adjacent finger modules among the plurality of finger modules, wherein each finger module of the plurality of finger modules comprises: a finger including a plurality of joints; a finger motor including a finger motor shaft configured to operate movement of the finger; an arrangement motor disposed parallel to the finger motor and including an arrangement motor shaft; a housing disposed beneath the finger and accommodating the finger motor and the arrangement motor; and an arrangement gear disposed concentrically with a center line of the arrangement motor shaft at an upper surface of the housing, and wherein, for the two adjacent finger modules that are connected by the connector, the arrangement gears of each finger module mesh with each other, and based on an operation of the arrangement motor, the finger module corresponding to the operated arrangement motor rotates about the arrangement motor shaft.

### BRIEF DESCRIPTION OF THE DRAWINGS

These and/or other aspects, features, and advantages of certain embodiments of the disclosure will be more apparent from the following description taken in conjunction with the accompanying drawings, in which:

FIG. 1 is a perspective view illustrating a robot hand according to one or more embodiments;

FIG. 2 is an exploded perspective view illustrating a robot hand according to one or more embodiments;

FIG. 3 is a cross-sectional view illustrating the robot hand according to one or more embodiments of FIG. 1 taken along line A-A;

FIG. 4 is a cross-sectional view illustrating the robot hand according to one or more embodiments of FIG. 1 taken along line B-B;

FIG. 5 is a perspective view illustrating a finger module according to one or more embodiments;

FIG. 6 is a perspective view illustrating a finger module according to one or more embodiments without a cover of a housing;

FIG. 7 is a cross-sectional view illustrating the finger module according to one or more embodiments of FIG. 5 taken along line C-C;

FIG. 8 is a perspective view illustrating a lower connecting link of a robot hand according to one or more embodiments;

FIG. 9 is a cross-sectional view illustrating the lower connecting link of the robot hand according to one or more embodiments of FIG. 8 taken along line D-D;

FIG. 10 is a cross-sectional view illustrating a state in which finger tips of two finger modules of a robot hand according to one or more embodiments of the disclosure have picked up an object.

FIG. 11 is a cross-sectional view illustrating a state in which fingers of two finger modules of a robot hand according to one or more embodiments are maximally spread apart;

FIG. 12 is a cross-sectional view illustrating a state in which a robot hand according to one or more embodiments grasps a cylindrical object;

FIG. 13 is a cross-sectional view illustrating a state in which a robot hand according to one or more embodiments grasps a cylindrical object;

FIG. 14 is a plan view illustrating a case in which four finger modules of a robot hand according to one or more embodiments are in a basic mode;

FIG. 15 is a plan view illustrating a case in which four finger modules of a robot hand according to one or more embodiments are in a first mode;

FIG. 16 is a plan view illustrating a case in which four finger modules of a robot hand according to one or more embodiments are in a second mode;

FIG. 17 is a plan view illustrating a case in which four finger modules of a robot hand according to one or more embodiments are in a third mode;

FIG. 18 is a plan view illustrating a case in which four finger modules of a robot hand according to one or more embodiments are in a fourth mode;

FIGS. 19A, 19B, and 19C are perspective views illustrating finger tips of a robot hand according to one or more embodiments;

FIG. 20 is a perspective view illustrating a robot hand according to one or more embodiments including two finger modules;

FIG. 21 is a plan view illustrating a robot hand according to one or more embodiments including three finger modules;

FIG. 22 is a block diagram illustrating a robot including robot hands according to one or more embodiments; and

FIG. 23 is a flowchart illustrating a motion of a robot including a robot hand according to one or more embodiments to pick up an object.

### DETAILED DESCRIPTION

Various embodiments of this document and terms used herein are not intended to limit the technical features described in this document to specific embodiments, but should be understood to include various modifications, equivalents, or alternatives of the embodiments.

In connection with the description of the drawings, similar reference numbers may be used for similar or related components.

The singular form of a noun corresponding to an item may include one or more of the above item, unless the relevant context clearly indicates otherwise.

As used herein, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof. For example, expressions such as “at least one of,” when preceding a list of elements, modify the entire list of elements and do not modify the individual elements of the list. For example, the expression, “at least one of A, B, or C,” should be understood as including only A, only B, only C, both A and B, both A and C, both B and C, or all of A, B, and C

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, it means that the one component can be connected to the another component directly (e.g., wired), wirelessly, or through a third component.

Terms such as “include,” “comprise,” or “have” are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure provides a robot hand capable of taking objects of various shapes by allowing arrangement of a plurality of finger modules to be changed.

The disclosure provides a robot hand including a plurality of finger modules equipped with passive adaptive mechanisms to securely grasp objects of various shapes.

A robot hand according to one or more embodiments of the disclosure may include: a plurality of finger modules; and a connecting part rotatably connecting two adjacent finger modules among the plurality of finger modules. Each of the plurality of finger modules may include: a finger including a plurality of joints; a finger motor including a finger motor shaft to operate the finger; an arrangement motor disposed parallel to the finger motor and including an arrangement motor shaft; a housing disposed beneath the finger and accommodating the finger motor and the arrangement motor; and an arrangement gear disposed concentrically with a center line of the arrangement motor shaft at one end of an upper surface of the housing. Two arrangement gears of the two adjacent finger modules connected by the connecting part may mesh with each other, and based on operating the arrangement motor, the finger module including the operated arrangement motor may rotate about the arrangement motor shaft.

According to one or more embodiments of the disclosure, the finger module may further include a rotation shaft formed to protrude from the upper surface of the housing in a direction opposite to the arrangement motor shaft in a straight line with the arrangement motor shaft. The connecting part may include: an upper connecting link connecting and rotatably supporting two rotation shafts of the two adjacent finger modules; a lower connecting link connecting two arrangement motor shafts of the two adjacent finger modules; and a base supporting the lower connecting link.

According to one or more embodiments of the disclosure, the upper connecting link may include two connecting holes into which the two rotation shafts are inserted; and two bearings disposed between the two connecting holes and the two rotation shafts.

According to one or more embodiments of the disclosure, the lower connecting link may include a fixed boss formed at one end thereof and a holding hole formed at another end thereof. One of the two arrangement motor shafts may be disposed in the fixed boss. The holding hole may be rotatably disposed in a holding boss, which is fixed to the base and in which another of the two arrangement motor shafts is disposed.

According to one or more embodiments of the disclosure, the connecting part may further include an upper holding link that is adjacent to the rotation shaft of one of the two adjacent finger modules and connects a rotation shaft of another finger module, which is not connected by the upper connecting link, among the plurality of finger modules.

According to one or more embodiments of the disclosure, the plurality of finger modules may include a first finger module, a second finger module, a third finger module, and a fourth finger module. The upper connecting link may include: a first upper connecting link connecting the rotation shaft of the first finger module and the rotation shaft of the second finger module; a second upper connecting link connecting the rotation shaft of the third finger module and the rotation shaft of the fourth finger module; and an upper holding link disposed on an upper side of the first upper connecting link and the second upper connecting link and configured to rotatably connect one end of the first upper connecting link and one end of the second upper connecting link.

According to one or more embodiments of the disclosure, the plurality of finger modules may include a first finger module, a second finger module, a third finger module, and a fourth finger module. The lower connecting link may include a first lower connecting link connecting the arrangement motor shaft of the first finger module and the arrangement motor shaft of the second finger module; a second lower connecting link connecting the arrangement motor shaft of the third finger module and the arrangement motor shaft of the fourth finger module; and a lower holding link disposed below the first lower connecting link and the second lower connecting link and configured to rotatably connect one end of the first lower connecting link and one end of the second lower connecting link.

According to one or more embodiments of the disclosure, the finger may include: a power transmission device disposed on one side of the finger motor and including a connecting rod for transmitting power of the finger motor; a first inner link having one end rotatably disposed on the upper surface of the housing; a second inner link rotatably connected to another end of the first inner link; a first outer link disposed facing the first inner link; a second outer link disposed facing the second inner link; a first ternary link rotatably connecting one end of the first inner link, one end of the first outer link, and one end of the connecting rod; a second ternary link rotatably connecting another end of the first inner link, another end of the first outer link, and one end of the second outer link; and a tip link rotatably connecting the second inner link and the second outer link.

According to one or more embodiments of the disclosure, the finger may further include a passive adaptation mechanism configured so that the first inner link and the second inner link apply force to an object according to a shape of the object contacting the first inner link and the second inner link, wherein the passive adaptation mechanism includes a plurality of passive links and a plurality of springs.

According to one or more embodiments of the disclosure, the passive adaptation mechanism may include: a first passive link including one end rotatably disposed coaxially with one end of the first inner link; a second passive link including one end rotatably disposed coaxially with another end of the first inner link; a third passive link including one end rotatably disposed coaxially with another end of the second inner link; a fourth passive link disposed between the first inner link and the first outer link and rotatably connecting another end of the first passive link and another end of the second passive link; a fifth passive link disposed between the second inner link and the second outer link and rotatably connecting the second passive link and another end of the third passive link; a first spring connecting another end of the first passive link and the housing; a second spring connecting one end of the first inner link and one end of the second inner link; and a third spring connecting another end of the third passive link and another end of the tip link.

According to one or more embodiments of the disclosure, the power transmission device may include: a pinion disposed on the finger motor shaft; a transmission gear meshed with the pinion; and a power conversion mechanism connected to the transmission gear and configured to convert rotation of the transmission gear into up-and-down movement of the connecting rod.

According to one or more embodiments of the disclosure, the power conversion mechanism may include: a ball screw on which the transmission gear is disposed; a ball nut screw-connected to the ball screw; a moving plate disposed on the ball nut and rotatably connected to another end of the connecting rod; and a guide rail guiding linear movement of the moving plate.

According to one or more embodiments of the disclosure, the finger module may include a finger tip detachably disposed at a leading end of the finger.

According to one or more embodiments of the disclosure, the robot hand may further include: a motor driver disposed in the housing and configured to control the finger motor and the arrangement motor; and a hand processor configured to control the motor driver.

According to one or more embodiments of the disclosure, the robot hand may further include: a limit sensor disposed in the housing and configured to limit a rotational angle of the finger; and an arrangement sensor in the housing and configured to limit a rotational angle of the housing.

Hereinafter, a robot hand 1 according to one or more embodiments of the disclosure will be described in detail with reference to the accompanying drawings.

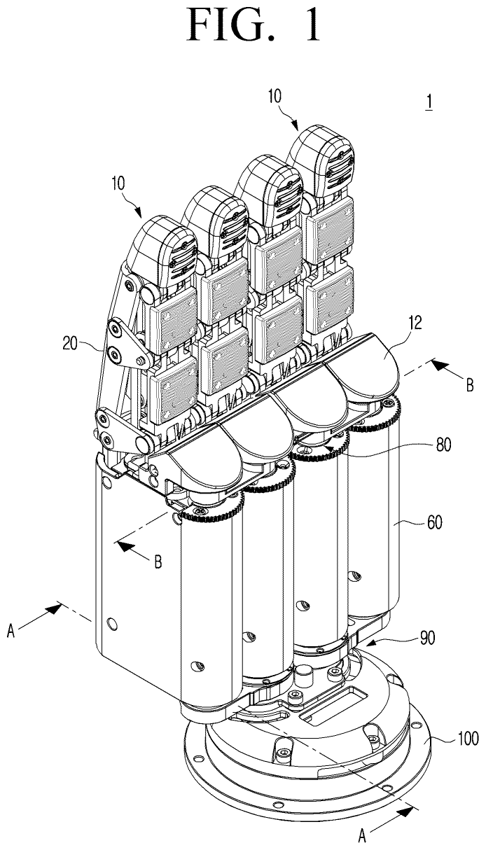

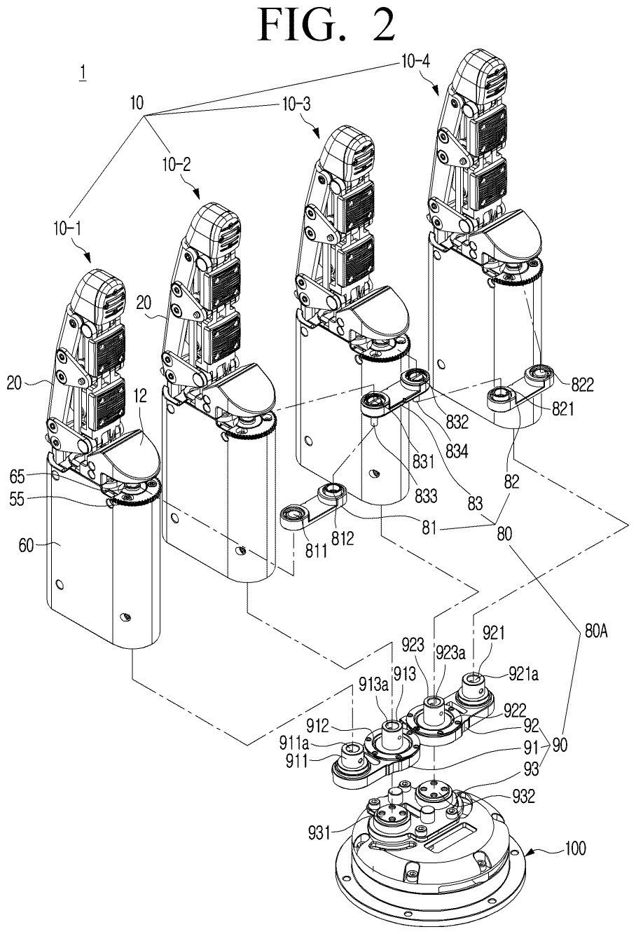

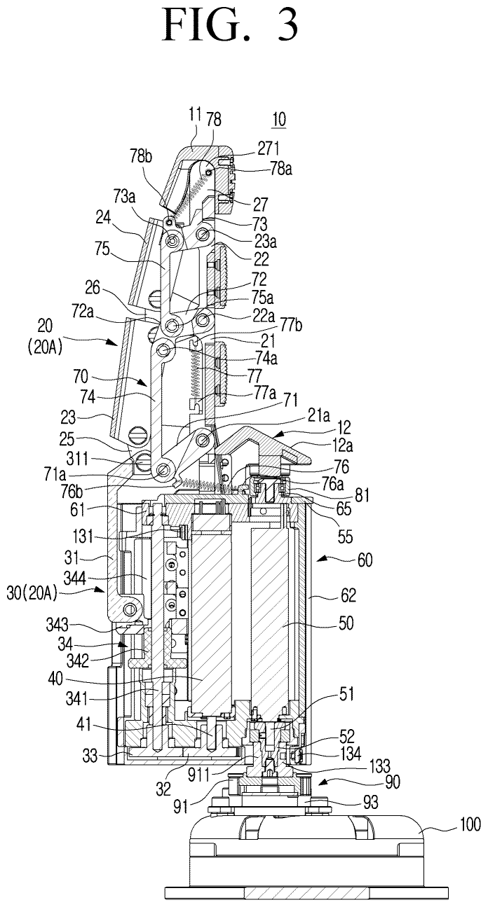

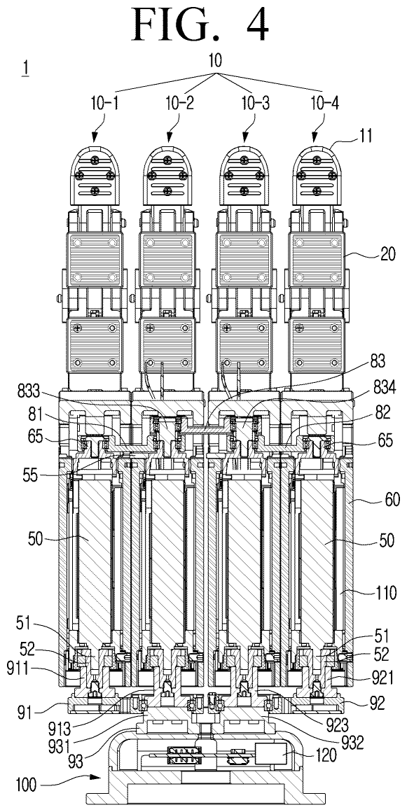

FIG. 1 is a perspective view illustrating a robot hand 1 according to one or more embodiments of the disclosure. FIG. 2 is an exploded perspective view illustrating a robot hand 1 according to one or more embodiments of the disclosure. FIG. 3 is a cross-sectional view illustrating the robot hand 1 according to one or more embodiments of the disclosure of FIG. 1 taken along line A-A. FIG. 4 is a cross-sectional view illustrating the robot hand 1 according to one or more embodiments of the disclosure of FIG. 1 taken along line B-B.

Referring to FIGS. 1, 2, 3 and 4, a robot hand 1 according to one or more embodiments of the disclosure may include a plurality of finger modules 10 and a connecting part 80A.

The plurality of finger modules 10 may be configured with the same structure. In some embodiments, each finger module 10 may be individual, separable modules. The plurality of finger modules 10 may be arranged in various ways by the connecting part 80A. The arrangement of the plurality of finger modules 10 may be changed so that the plurality of finger modules 10 take objects of various shapes. In other words, the arrangement of the plurality of finger modules 10 may be changed depending on the shape of the object to be taken by the robot hand 1.

Here, taking an object may refer to picking or grasping the object. Picking may refer to taking an object with the leading portions (e.g., finger tips 11) of the plurality of facing finger modules 10, and grasping may refer to taking an object with the middle portions (e.g., a first inner link 21 and a second inner link 22) of the plurality of facing finger modules 10.

For example, the plurality of finger modules 10 may be arranged to pick up a small or thin object. In other words, the plurality of finger modules 10 may be arranged to perform tasks such as tape removal, connector assembly, and the like.

For example, the plurality of finger modules 10 may be arranged to grasp medium sized or irregularly shaped objects. In other words, the plurality of finger modules 10 may be arranged to grasp hoses, spherical parts, or parts having a roughly bar or rod shape, such as pipes or cylinders. The bar shape may have various cross-sections, such as circular, oval, or polygonal.

For example, the plurality of finger modules 10 may be arranged in a configuration optimal for taking the object, depending on the shape of the object to be taken. In other words, the plurality of finger modules 10 according to one or more embodiments of the disclosure may not be limited to the arrangement illustrated in FIG. 1 and may be rearranged in various ways depending on the size, shape, and posture of the object.

The robot hand 1 according to one or more embodiments of the disclosure may include two or more finger modules 10. The robot hand 1 according to the embodiment illustrated in FIGS. 1, 2, 3, and 4 may include four finger modules 10, namely, a first finger module, a second finger module, a third finger module, and a fourth finger module. However, the number of finger modules 10 of the robot hand 1 according to one or more embodiments of the disclosure may not be limited thereto. The robot hand 1 may include two finger modules 10, three finger modules 10, or five finger modules 10.

The finger module 10 may include an arrangement motor 50 configured to rotate the finger module 10 to change the arrangement of the finger module 10. The arrangement motor 50 may include an arrangement motor shaft 51. When the arrangement motor 50 operates, the arrangement motor shaft 51 may rotate. For example, the arrangement motor 50 may be configured as a servo motor, a stepping motor, etc.

The finger module 10 may include a rotation shaft 65 formed to protrude from one surface of a housing 60 in a direction opposite to the arrangement motor shaft 51 and in a straight line with the arrangement motor shaft 51. The center line of the arrangement motor shaft 51 and the center line of the rotation shaft 65 may be arranged in a straight line.

The connecting part 80A may be configured to rotatably connect two adjacent finger modules 10 among the plurality of finger modules 10. The connecting part 80A may connect the plurality of finger modules 10 so that the arrangement of the plurality of finger modules 10 is changed.

The connecting part 80A may include an upper connecting link 80 and a lower connecting link 90. For example, the upper connecting link 80 may be configured to connect and rotatably support the two rotation shafts 65 of two adjacent finger modules 10. The lower connecting link 90 may be configured to connect and support two arrangement motor shafts 51 of the two adjacent finger modules 10.

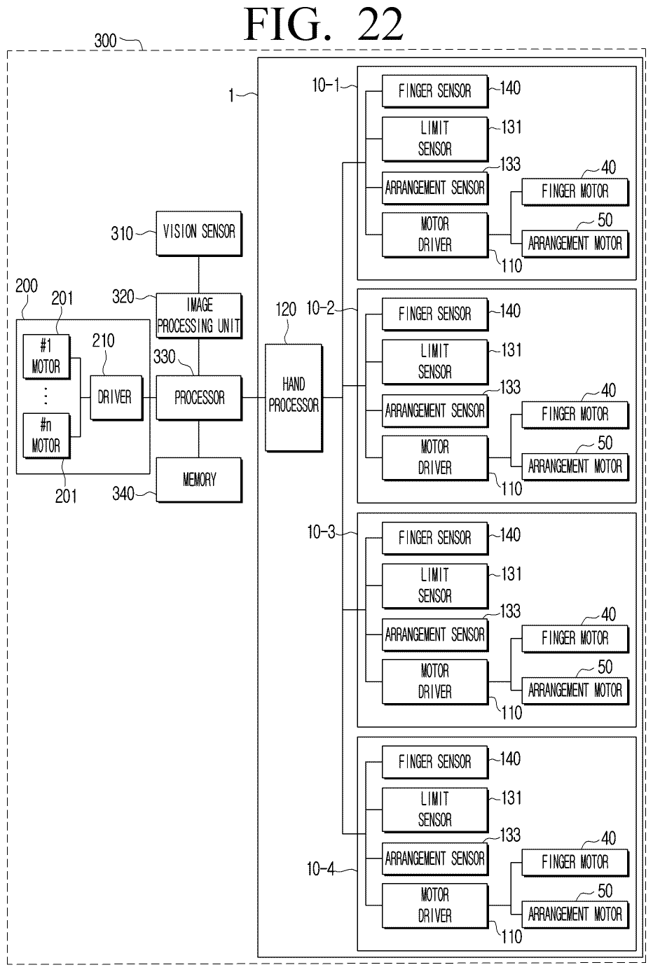

The connecting part 80A may include a base 100 configured to support the lower connecting link 90. The base 100 may be provided below the lower connecting link 90. The base 100 may be configured so that the robot hand 1 according to one or more embodiments of the disclosure is disposed at the leading end of a robot arm 200 (see FIG. 22). The position and posture of the robot hand 1 may be changed by the robot arm 200.

Because the plurality of finger modules 10 are configured identically, a single finger module 10 will be described in detail below.

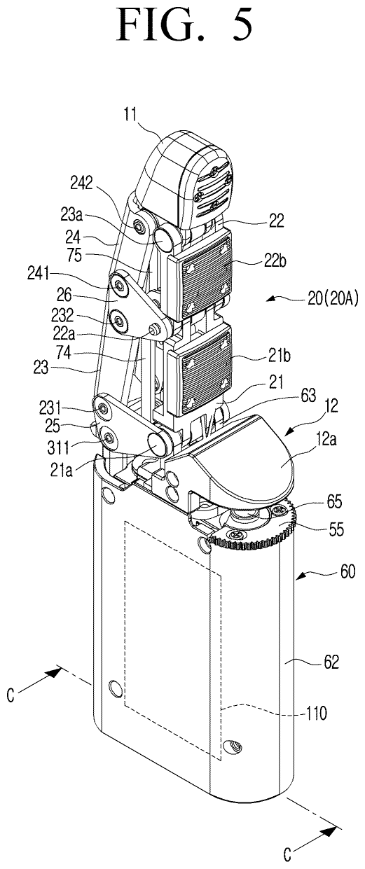

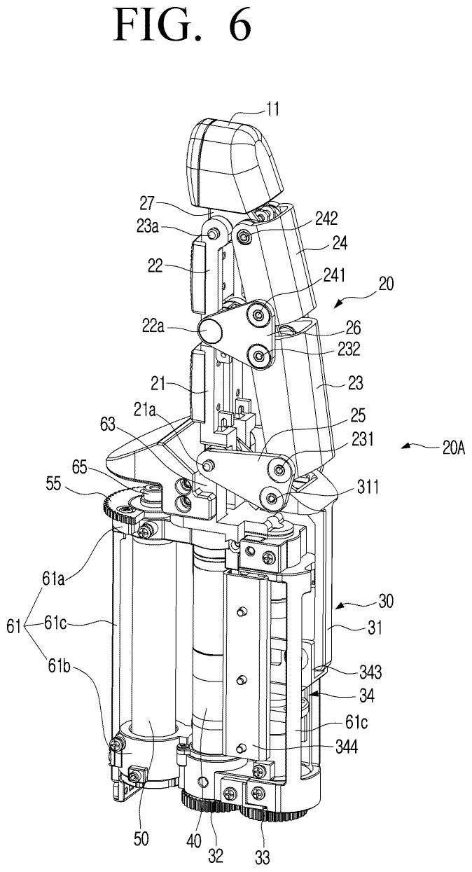

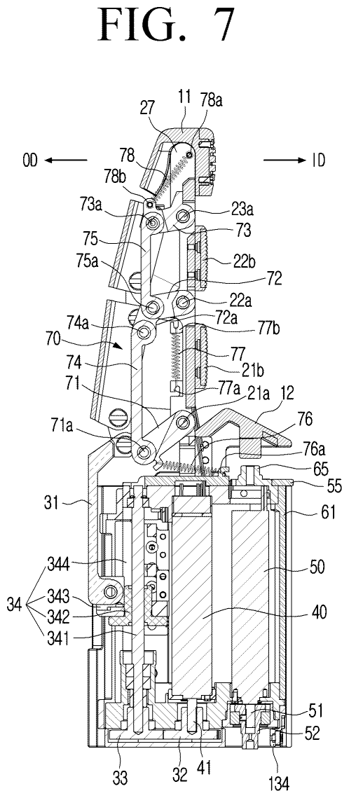

FIG. 5 is a perspective view illustrating a finger module 10 according to one or more embodiments of the disclosure. FIG. 6 is a perspective view illustrating a finger module 1 according to one or more embodiments of the disclosure with a cover 62 of a housing 60 removed. FIG. 7 is a cross-sectional view illustrating the finger module 10 according to one or more embodiments of the disclosure taken along line C-C of FIG. 5.

Referring to FIGS. 5, 6, and 7, the finger module 10 according to one or more embodiments of the disclosure may include a finger part 20A, a finger motor 40, the arrangement motor 50, and a housing 60.

The finger part 20A may be configured to pick or grasp an object. For example, the finger part 20A may include a finger 20 and a power transmission device 30.

The finger 20 may be configured to pivot at a certain angle relative to the housing 60. The finger 20 may include a plurality of joints. The finger 20 may include a plurality of joints and a plurality of segments. As an example, the finger 20 may include three joints and three segments.

For example, the finger 20 may include a first inner link 21, a second inner link 22, a first outer link 23, a second outer link 24, a first ternary link 25, a second ternary link 26, and a tip link 27.

The first inner link 21 may be rotatably disposed on the upper surface of the housing 60. One end of the first inner link 21 may be rotatably disposed on the upper surface of the housing 60, and the other end thereof may be rotatably connected to one end of the second inner link 22.

For example, the first inner link 21 may be formed in a roughly rectangular flat plate shape. A pair of first lower hinge holes may be formed at one end of the first inner link 21. A pair of first upper hinge holes may be formed at the other end of the first inner link 21.

The housing 60 may include a pair of support brackets 63. The pair of support brackets 63 may be disposed on the upper surface of the housing 60. The pair of support brackets 63 may connect the finger 20 and the housing 60 and may be configured to rotatably support the finger 20.

The pair of support brackets 63 may include hinge holes. The hinge holes of the pair of support brackets 63 may be formed to correspond to the pair of first lower hinge holes of the first inner link 21. When a first hinge shaft 21a is inserted into the pair of first lower hinge holes of the first inner link 21 and the hinge holes of the pair of support brackets 63 of the housing 60, the first inner link 21 may be rotatably connected to the upper surface of the housing 60.

A first grasp part 21b may be disposed on the outer surface of the first inner link 21. The first grasp part 21b may be formed in a roughly flat shape, and may have unevenness formed on one surface to increase frictional force.

The second inner link 22 may be rotatably connected to the other end of the first inner link 21. One end of the second inner link 22 may be rotatably disposed to the other end of the first inner link 21, and the other end thereof may be rotatably connected to the tip link 27.

For example, the second inner link 22 may be formed in a roughly rectangular flat plate shape. A pair of second lower hinge holes may be formed at one end of the second inner link 22. A pair of second upper hinge holes may be formed at the other end of the second inner link 22.

When a second hinge shaft 22a is inserted into the pair of first upper hinge holes of the first inner link 21 and the pair of second lower hinge holes of the second inner link 22, the first inner link 21 and the second inner link 22 may be rotatably connected to each other.

A second grasp part 22b may be disposed on the outer surface of the second inner link 22. The second grasp part 22b may be formed in a roughly flat shape, and may have unevenness formed on one surface to increase frictional force.

The first outer link 23 may be disposed to face the first inner link 21. One end of the first outer link 23 may be connected to the power transmission device 30, and the other end thereof may be rotatably connected to the second outer link 24. For example, one end of the first outer link 23 may be rotatably connected to a connecting rod 31 of the power transmission device 30. Therefore, the first outer link 23 may be configured to receive power from the power transmission device 30.

The first outer link 23 may be formed in a channel shape, approximately U-shaped. A pair of first lower hinge pins 231, that is, a first lower left hinge pin and a first lower right hinge pin, may be formed at one end of the first outer link 23. A pair of first upper hinge pins 232, that is, a first upper left hinge pin and a first upper right hinge pin, may be formed at the other end of the first outer link 23.

The second outer link 24 may be disposed to face the second inner link 22. The second outer link 24 may be rotatably connected to the first outer link 23. One end of the second outer link 24 may be rotatably connected to the other end of the first outer link 23, and the other end thereof may be rotatably connected to the tip link 27.

The second outer link 24 may be formed in a channel shape, approximately U-shaped. A pair of second lower hinge pins 241, that is, a second lower left hinge pin and a second lower right hinge pin, may be formed at one end of the second outer link 24. A pair of second upper hinge pins 242, that is, a second upper left hinge pin and a second upper right hinge pin, may be formed at the other end of the second outer link 24.

The first ternary link 25 may be formed to rotatably connect one end of the first inner link 21, one end of the first outer link 23, and one end of the connecting rod 31. The first ternary link 25 may be formed in an approximately triangular shape. The first ternary link 25 may include three hinge holes. The three hinge holes may be formed adjacent to three vertices of the first ternary link 25.

For example, the first ternary link 25 may include a first hinge hole, a second hinge hole, and a third hinge hole.

The first hinge hole of the first ternary link 25 may be rotatably connected to one end of the first inner link 21. In other words, the first hinge hole of the first ternary link 25 may be rotatably connected to one end of the first inner link 21 and the support bracket 63 of the housing 60.

For example, the first ternary link 25 may include a pair of first ternary links 25, that is, a first left ternary link and a first right ternary link. The pair of first ternary links 25 may be disposed on both sides of the pair of support brackets 63 of the housing 60, that is, the left support bracket 63 and the right support bracket 63, respectively. When the first hinge shaft 21a is inserted into the first hinge holes of the first ternary links 25, the hinge holes of the pair of support brackets 63, and the first lower hinge holes of the first inner link 21, the first ternary link 25 and the first inner link 21 may be rotatably connected to the pair of support brackets 63.

The second hinge holes of the pair of first ternary links 25 may be rotatably connected to one end of the first outer link 23. In other words, the second hinge hole of the first ternary link 25 may be rotatably connected to the first lower hinge pin 231 of the first outer link 23.

For example, the first lower left hinge pin 231 of one end of the first outer link 23 may be inserted into the second hinge hole of the first left ternary link 25. The first lower right hinge pin 231 of one end of the first outer link 23 may be inserted into the second hinge hole of the first right ternary link 25. Therefore, the first outer link 23 may be rotatably connected to the pair of first ternary links 25.

The third hinge holes of the pair of first ternary links 25 may be rotatably connected to one end of the connecting rod 31. In other words, the third hinge hole of the first ternary link 25 may be rotatably connected to the hinge pin 311 provided at one end of the connecting rod 31.

For example, a left hinge pin 311 of one end of the connecting rod 31 may be inserted into the third hinge hole of the first left ternary link 25. A right hinge pin 311 of one end of the connecting rod 31 may be inserted into the third hinge hole of the first right ternary link 25. Accordingly, the pair of first ternary links 25 may be rotatably connected to the connecting rod 31.

The second ternary link 26 may be configured to connect the other end of the first inner link 21, the other end of the first outer link 23, and one end of the second outer link 24. The second ternary link 26 may be formed in an approximately triangular shape. The second ternary link 26 may include three hinge holes. The three hinge holes may be formed adjacent to three vertices of the second ternary link 26.

For example, the second ternary link 26 may include a first hinge hole, a second hinge hole, and a third hinge hole.

The first hinge hole of the second ternary link 26 may be rotatably connected to the other end of the first inner link 21. In other words, the first hinge hole of the second ternary link 26 may be rotatably connected to the other end of the first inner link 21 and one end of the second inner link 22.

For example, the second ternary link 26 may include a pair of second ternary links 26, that is, a second left ternary link and a second right ternary link. The pair of second ternary links 26 may be disposed on both sides of the second inner link 22. When the second hinge shaft 22a is inserted into the first hinge holes of the pair of second ternary links 26, the second lower hinge hole of one end of the second inner link 22, and the first upper hinge holes of the first inner link 21, the second ternary link 26 and the second inner link 22 may be rotatably connected to the other end of the first inner link 21.

The second hinge holes of the pair of second ternary links 26 may be rotatably connected to one end of the second outer link 24. In other words, the second hinge hole of the second ternary link 26 may be rotatably connected to the second lower hinge pin 241 of the second outer link 24.

For example, the second lower left hinge pin 241 of one end of the second outer link 24 may be inserted into the second hinge hole of the second left ternary link 26. The second lower right hinge pin 241 of one end of the second outer link 24 may be inserted into the second hinge hole of the second right ternary link 26. Therefore, the second outer link 24 may be rotatably connected to the pair of second ternary links 26.

The third hinge holes of the pair of second ternary links 26 may be rotatably connected to the other end of the first outer link 23. In other words, the third hinge hole of the second ternary link 26 may be rotatably connected to the first upper hinge pin 232 provided at the other end of the first outer link 23.

For example, the first upper left hinge pin 232 of the other end of the first outer link 23 may be inserted into the third hinge hole of the second left ternary link 26. The first upper right hinge pin 232 of the other end of the first outer link 23 may be inserted into the third hinge hole of the second right ternary link 26. Accordingly, the pair of second ternary links 26 may be rotatably connected to the other end of the first outer link 23.

Accordingly, the other end of the first inner link 21, the other end of the first outer link 23, and one end of the second outer link 24 may be rotatably connected by the pair of second ternary links 26.

The tip link 27 may be formed to connect the second inner link 22 and the second outer link 24. In other words, the other end of the second inner link 22 and the other end of the second outer link 24 may be rotatably connected by the tip link 27.

The tip link 27 may include an inner hinge hole and an outer hinge hole.

The inner hinge hole of the tip link 27 may be rotatably connected to the second hinge hole of the second inner link 22. For example, the tip link 27 may include a pair of inner hinge holes. When a third hinge shaft 23a is inserted into the pair of second upper hinge holes of the second inner link 22 and the pair of inner hinge holes of the tip link 27, the second inner link 22 and the tip link 27 may be rotatably connected.

The outer hinge hole of the tip link 27 may be rotatably connected to the second upper hinge pin 242 of the second outer link 24. The tip link 27 may include a pair of outer hinge holes. The second outer link 24 may include a pair of second upper hinge pins 242. Therefore, when the pair of second upper hinge pins 242 of the second outer link 24 are inserted into the pair of outer hinge holes of the tip link 27, the tip link 27 and the other end of the second outer link 24 may be rotatably connected.

The tip link 27 may be formed to have an approximately triangular cross-section. The inner hinge hole and the outer hinge hole may be formed near the vertices of the triangle.

The tip link 27 may be configured so that a finger tip 11 is mounted on the tip link 27. The finger tip 11 may be detachably disposed on the tip link 27. The tip link 27 may include a tip mounting portion 271 to which the finger tip 11 is mounted (see FIG. 3). The tip mounting portion 271 may be formed on the upper portion of the tip link 27. The inner hinge hole and the outer hinge hole may be formed on the lower portion of the tip link 27, that is, below the tip mounting portion 271. When the robot hand 1 picks an object, the object may be positioned between the plurality of facing finger tips 11.

The power transmission device 30 may be configured to transmit power from the finger motor 40 to the finger 20. The power transmission device 30 may be disposed in the housing 60 on one side of the finger motor 40. The power transmission device 30 may include the connecting rod 31.

The connecting rod 31 may be configured to be rotatably connected to one end of the first outer link 23 so as to move the first outer link 23 up and down. The connecting rod 31 may be rotatably connected to one end of the first outer link 23 by the first ternary link 25.

A pair of hinge pins 311 may be provided at one end of the connecting rod 31. For example, a left hinge pin and a right hinge pin may be provided at one end of the connecting rod 31. The pair of hinge pins 311 of the connecting rod 31 may be inserted into the third hinge holes of the pair of first ternary links 25. Therefore, one end of the connecting rod 31 may be rotatably connected to the third hinge hole of the first ternary link 25.

For example, the power transmission device 30 may include a pinion 32, a transmission gear 33, and a power conversion mechanism 34.

The pinion 32 may be disposed on the finger motor shaft 41 of the finger motor 40. The pinion 32 may be disposed to rotate integrally with the finger motor shaft 41.

The transmission gear 33 may be disposed to mesh with the pinion 32. For example, the transmission gear 33 may be disposed on the power conversion mechanism 34.

The power conversion mechanism 34 may be connected to the transmission gear 33 and configured to convert the rotation of the transmission gear 33 into linear movement. Accordingly, the connecting rod 31 may be moved up and down by the power conversion mechanism 34.

For example, the power conversion mechanism 34 may include a ball screw 341 on which the transmission gear 33 is disposed, a ball nut 342 screw-connected to the ball screw 341, a moving plate 343 disposed on the ball nut 342 and rotatably connected to the other end of the connecting rod 31, and a guide rail 344 configured to guide the linear movement of the moving plate 343. Both ends of the ball screw 341 may be rotatably supported on the housing 60. The guide rail 344 may be disposed in the housing 60 parallel to the ball screw 341.

Therefore, when the transmission gear 33 rotates, the ball screw 341 rotates integrally with the transmission gear 33. When the ball screw 341 rotates, the moving plate 343 may move linearly up and down by the ball nut 342. Accordingly, the connecting rod 31 may move up and down by the moving plate 343.

In the above, the power conversion mechanism 34 is described as an example in which the power conversion mechanism 34 is formed with the ball screw 341 and the ball nut 342, but the power conversion mechanism 34 may not be limited thereto. The power conversion mechanism 34 may have various structures as long as it can convert the rotational motion into linear movement.

The finger motor 40 may be configured to generate rotational force capable of operating the finger 20. For example, the finger motor 40 may be configured by a servo motor, a stepping motor, etc.

The finger motor 40 may include the finger motor shaft 41. The finger motor 40 may fixed to the housing 60. The finger motor 40 may be disposed in the housing 60 such that the finger motor shaft 41 faces downward of the housing 60. The pinion 32 may be disposed on the finger motor shaft 41. Accordingly, when the finger motor 40 operates, the pinion 32 may rotate integrally with the finger motor shaft 41. The pinion 32 and the transmission gear 33 may be disposed at a lower portion of the housing 60.

When the finger motor 40 rotates in one direction, the connecting rod 31 of the power transmission device 30 may move upward. When the connecting rod 31 moves upward, the finger tip 11 disposed on the tip link 27 may move inward by the first outer link 23, the second outer link 24, the first inner link 21, the second inner link 22, the first ternary link 25, and the second ternary link 26. In other words, when the connecting rod 31 moves upward, the finger 20 may move in an inward direction ID around one end of the first inner link 21, that is, the first hinge shaft 21a.

Here, the inward direction ID of the finger 20 refers to the direction from the first outer link 23 to the first inner link 21, as indicated by the arrow ID in FIG. 7, and an outward direction OD of the finger 20 refers to the direction from the first inner link 21 to the first outer link 23, as indicated by the arrow OD in FIG. 7. Therefore, the inward direction ID and the outward direction OD of the finger 20 are opposite directions.

When the finger motor 40 rotates in the opposite direction, the connecting rod 31 of the power transmission device 30 may move downward. When the connecting rod 31 moves downward, the finger tip 11 disposed on the tip link 27 may move in the outward direction OD by the first outer link 23, the second outer link 24, the first inner link 21, the second inner link 22, the first ternary link 25, and the second ternary link 26. In other words, when the connecting rod 31 moves downward, the finger 20 may move in the outward direction OD around one end of the first inner link 21, that is, the first hinge shaft 21a. That is, the translational movement of the connecting rod 31 generates rotational movement of the finger 20.

The finger part 20A may further include a passive adaptation mechanism 70 configured to cause the first inner link 21 and the second inner link 22 to apply force to an object depending on the shape of the objection in contact with the first inner link 21 and the second inner link 22. For example, when an object is positioned between two finger parts 20A in which the first inner links 21 and the second inner links 22 of one finger part 20A are arranged to face the first inner links 21 and the second inner links 22 of another finger part 20A, the angle between the first inner link 21 and the second inner link 22 of each finger part 20A may be changed in accordance with the shape of the object by the passive adaptation mechanisms 70 provided in each finger part 20A, and the first inner links 21 and the second inner links 22 may apply force to firmly grasp the object. The passive adaptation mechanism 70 may be disposed inside the finger 20.

For example, the passive adaptation mechanism 70 may include a plurality of passive links and a plurality of springs. As an example, the passive adaptation mechanism 70 may include a first passive link 71, a second passive link 72, a third passive link 73, a fourth passive link 74, a fifth passive link 75, a first spring 76, a second spring 77, and a third spring 78.

One end of the first passive link 71 may be rotatably connected to one end of the first inner link 21 and coaxially with one end of the first inner link 21. For example, one end of the first passive link 71 may be rotatably disposed on the first hinge shaft 21a. In other words, one end of the first passive link 71 may be rotatably disposed on the first hinge shaft 21a that is inserted into the first lower hinge holes of one end of the first inner link 21 and the hinge holes of the pair of support brackets 63. Accordingly, the first passive link 71 may rotate independently of the first inner link 21 about the first hinge shaft 21a.

The first passive link 71 may be formed in a roughly straight bar shape. One end of the first passive link 71 may be rotatably connected to the first hinge shaft 21a disposed on the pair of support brackets 63 of the housing 60, and the other end thereof may be rotatably connected to one end of the fourth passive link 74. The first passive link 71 may be positioned between the pair of first ternary links 25.

One end of the second passive link 72 may be rotatably connected to the other end of the first inner link 21 and coaxially with the other end of the first inner link 21. For example, one end of the second passive link 72 may be rotatably disposed on the second hinge shaft 22a. In other words, one end of the second passive link 72 may be rotatably disposed on the second hinge shaft 22a that is inserted into the first upper hinge hole of the other end of the first inner link 21 and the second lower hinge hole of one end of the second inner link 22. Accordingly, the second passive link 72 may rotate independently of the first inner link 21 and the second inner link 22 about the second hinge shaft 22a.

The second passive link 72 may be formed in a roughly bent bar shape. One end of the second passive link 72 may be rotatably connected to the second hinge shaft 22a disposed at the other end of the first inner link 21, and the other end thereof may be rotatably connected to the other end of the fourth passive link 74. A bent portion 72a of the second passive link 72 may be rotatably connected to one end of the fifth passive link 75. The hinge axis 74a of the other end of the fourth passive link 74 and the hinge axis 75a of one end of the fifth passive link 75 may be spaced apart from each other by a certain distance.

The second passive link 72 may be positioned between the pair of second ternary links 26.

One end of the third passive link 73 may be rotatably connected to the other end of the second inner link 22 and coaxially with the other end of the second inner link 22. For example, one end of the third passive link 73 may be rotatably disposed on the third hinge shaft 23a. In other words, one end of the third passive link 73 may be rotatably disposed on the third hinge shaft 23a that is inserted into the second upper hinge hole of the other end of the second inner link 22 and the inner hinge hole of the tip link 27. Accordingly, the third passive link 73 may rotate independently of the second inner link 22 and the tip link 27 about the third hinge shaft 23a.

The third passive link 73 may be formed in a roughly straight bar shape. One end of the third passive link 73 may be rotatably connected to the third hinge shaft 23a inserted into the second upper hinge hole of the other end of the second inner link 22, and the other end thereof may be rotatably connected to the other end of the fifth passive link 75. The third passive link 73 may be disposed so as not to interfere with the tip link 27.

The fourth passive link 74 may be disposed between the first inner link 21 and the first outer link 23. The fourth passive link 74 may be formed to rotatably connect the other end of the first passive link 71 and the other end of the second passive link 72. One end of the fourth passive link 74 and the other end of the first passive link 71 may be connected by a hinge pin 71a. Therefore, the fourth passive link 74 and the first passive link 71 may rotate relative to each other about the hinge pin 71a. The other end of the fourth passive link 74 and the other end of the second passive link 72 may be connected by a hinge pin 74a. Therefore, the fourth passive link 74 and the second passive link 72 may rotate relative to each other about the hinge pin 74a.

The fifth passive link 75 may be disposed between the second inner link 22 and the second outer link 24. The fifth passive link 75 may be formed to rotatably connect the second passive link 72 and the third passive link 73. One end of the fifth passive link 75 may be rotatably connected to the bent portion 72a of the second passive link 72. For example, one end of the fifth passive link 75 may be connected to the bent portion 72a of the second passive link 72 by a hinge pin 75a. Therefore, the fifth passive link 75 and the second passive link 72 may rotate relative to each other about the hinge pin 75a. The other end of the fifth passive link 75 and the other end of the third passive link 73 may be connected by a hinge pin 73a. Therefore, the fifth passive link 75 and the third passive link 73 may rotate relative to each other about the hinge pin 73a.

The first spring 76 may be disposed to connect the first passive link 71 and the housing 60. The first spring 76 may be configured to apply a pulling force to the first passive link 71 toward the housing 60. For example, the first spring 76 may be disposed to connect the other end of the first passive link 71 and the upper surface of the housing 60.

A first catch 76a on which one end of the first spring 76 is caught may be provided on the upper surface of the housing 60. The first catch 76a may be disposed adjacent to the rotation shaft 65 of the housing 60. A second catch 76b on which the other end of the first spring 76 is caught may be provided on the other end of the first passive link 71. Therefore, when both ends of the first spring 76 are caught to the first catch 76a and the second catch 76b, a pulling force toward the housing 60 may be applied to the first passive link 71. Then, the first passive link 71 may rotate counterclockwise about the first hinge shaft 21a by the first spring 76.

The second spring 77 may be disposed to connect the first inner link 21 and the second inner link 22. The second spring 77 may be configured to apply a downward force, i.e., a force pulling toward one end of the first inner link 21, to the second inner link 22. Accordingly, the second inner link 22 may be maintained in a straight line with the first inner link 21 by the second spring 77. For example, the second spring 77 may be disposed to connect one end of the second inner link 22 and one end of the first inner link 21.

A third catch 77a on which one end of the second spring 77 is caught may be provided on the inner surface of the first inner link 21. The third catch 77a may be disposed adjacent to and above one end of the first inner link 21. The third catch 77a may be provided on the upper side of the first hinge shaft 21a. A fourth catch 77b on which the other end of the second spring 77 is caught may be provided on one end of the second inner link 22. The fourth catch 77b may be formed at a position where the second inner link 22 may be in a straight line with the first inner link 21 by the second spring 77. The fourth catch 77b may be provided to protrude below one end of the second inner link 22, i.e., toward the first inner link 21. Therefore, when both ends of the second spring 77 are caught on the third catch 77a and the fourth catch 77b, the first inner link 21 and the second inner link 22 may receive a force that tries to keep the first inner link 21 and the second inner link 22 in a straight line.

The third spring 78 may be disposed to connect the third passive link 73 and the tip link 27. The third spring 78 may be configured to apply an upward force, i.e., a pulling force toward the other end of the tip link 27, to the third passive link 73. For example, the third spring 78 may be disposed to connect the other end of the third passive link 73 and the other end of the tip link 27.

A fifth catch 78a on which one end of the third spring 78 is caught may be provided on the other end of the tip link 27. The fifth catch 78a may be disposed adjacent to the other end of the tip link 27 above the inner hinge hole of the tip link 27. A sixth catch 78b on which the other end of the third spring 78 is caught may be provided at the other end of the third passive link 73. Accordingly, when both ends of the third spring 78 are caught on the fifth catch 78a and the sixth catch 78b, the third passive link 73 may receive a force that rotates the third passive link 73 clockwise about the third hinge shaft 23a.

When the passive adaptation mechanism 70 is formed in this manner, the angle between the first inner link 21 and the second inner link 22 may change depending on the shape of an object in contact, so that the first inner link 21 and the second inner link 22 may apply force to the object. In addition, when the object is removed, the first inner link 21 and the second inner link 22 may be restored to a straight state by the passive adaptation mechanism 70.

The housing 60 may be configured to support the finger 20 and accommodate the finger motor 40 and the arrangement motor 50. The housing 60 may include a frame 61 and a cover 62.

The frame 61 may be configured to accommodate and support the arrangement motor 50, the finger motor 40, and the power transmission device 30. The frame 61 may include an upper frame 61a, a lower frame 61b, and a vertical frame 61c connecting the upper frame 61a and the lower frame 61b. The arrangement motor 50, the finger motor 40, and the power transmission device 30 may be arranged between the upper frame 61a and the lower frame 61b.

The arrangement motor 50 may be disposed to be fixed to the frame 61. The arrangement motor 50 may include an arrangement motor shaft 51. The arrangement motor shaft 51 may be fixed to the lower connecting link 90. For example, the arrangement motor shaft 51 may be fixed to the lower connecting link 90 using an adapter 52. The adapter 52 may be configured to connect the arrangement motor shaft 51 and the lower connecting link 90. One end of the adapter 52 may be coupled to the arrangement motor shaft 51, and the other end thereof may be coupled to the lower connecting link 90. Therefore, when the arrangement motor shaft 51 rotates, the frame 61, i.e., the housing 60 to which the arrangement motor 50 is fixed, may rotate about the arrangement motor shaft 51 such that the finger module 10 rotates about a center axis.

The finger motor 40 may be disposed to be fixed to the frame 61. The finger motor 40 may be disposed parallel to the arrangement motor 50. The finger motor 40 may include a finger motor shaft 41. The finger motor 40 may be disposed in the frame 61 such that the finger motor shaft 41 is positioned at the lower portion of the frame 61, similar to the arrangement motor 50.

The power transmission device 30 may be configured to transmit power from the finger motor 40 to the finger 20. For example, the power transmission device 30 may include a pinion 32, a transmission gear 33, and a power conversion mechanism 34.

The pinion 32 may be disposed on the finger motor shaft 41. Therefore, when the finger motor shaft 41 rotates, the pinion 32 may rotate integrally with the finger motor shaft 41.

The transmission gear 33 may be disposed on the lower portion of the frame 61. The transmission gear 33 may be disposed to mesh with the pinion 32. Therefore, when the pinion 32 rotates, the transmission gear 33 may rotate. As an example, the pinion 32 and the transmission gear 33 may be configured as spur gears.

The power conversion mechanism 34 may be connected to the transmission gear 33 and may be configured to convert the rotation of the transmission gear 33 into the up-and-down movement of the connecting rod 31. In other words, the power conversion mechanism 34 may be connected to the transmission gear 33 and may be configured to covert the rotation of the transmission gear 33 into a linear movement to move the connecting rod 31 up and down.

For example, the power conversion mechanism 34 may include a ball screw 341 and a ball nut 342. Both ends of the ball screw 341 may be disposed so that they are supported by the frame 61. The transmission gear 33 may be disposed at one end of the ball screw 341. Therefore, when the transmission gear 33 rotates, the ball screw 341 may rotate integrally with the transmission gear 33.

The ball screw 341 may include the ball nut 342. The ball nut 342 may be screw-coupled to the ball screw 341. Therefore, when the ball screw 341 rotates, the ball nut 342 may move linearly along the ball screw 341.

A moving plate 343 may be disposed on the ball nut 342. Therefore, when the ball nut 342 moves, the moving plate 343 may move integrally with the ball nut 342.

The other end of the connecting rod 31 may be rotatably connected to the moving plate 343. Therefore, when the moving plate 343 moves, the connecting rod 31 may move integrally with the moving plate 343. For example, when the ball nut 342 moves upward along the ball screw 341, the moving plate 343 may rise, and when the moving plate 343 moves upward, the connecting rod 31 may rise. When the ball nut 342 moves downward along the ball screw 341, the connecting rod 31 may descend.

The linear movement of the moving plate 343 may be guided by a guide rail 344. The guide rail 344 may be fixed to the frame 61.

Accordingly, when the finger motor shaft 41 rotates, the ball screw 341 may rotate by the pinion 32 and the transmission gear 33. When the ball screw 341 rotates, the connecting rod 31 may move up and down by the moving plate 343 disposed on the ball nut 342. When the connecting rod 31 moves up and down, the finger 20 may rotate at a certain angle about the first hinge shaft 21a.

The housing 60 may include the rotation shaft 65. The rotation shaft 65 may be formed to protrude from the upper surface of the housing 60 in a direction opposite to the arrangement motor shaft 51 in a straight line with the arrangement motor shaft 51. For example, the rotation shaft 65 may be formed on the upper surface of the frame 61. The rotation shaft 65 may be disposed so that the center line of the rotation shaft 65 and the center line of the arrangement motor shaft 51 are aligned. The arrangement motor shaft 51 may be disposed to face the lower side of the frame 61, and the rotation shaft 65 may be formed to protrude upward from the upper surface of the frame 61. Because the arrangement motor shaft 51 is fixed to the lower connecting link 90, when the arrangement motor 50 operates, the housing 60 may rotate about the center line of the arrangement motor shaft 51 and the rotation shaft 65.

The housing 60 may include an arrangement gear 55. The arrangement gear 55 may be disposed concentrically with the rotation shaft 65 at one end of the upper surface of the housing 60. For example, the arrangement gear 55 may be disposed at one end of the upper surface of the frame 61. The arrangement gear 55 may be disposed concentrically with the arrangement motor shaft 51. In other words, the arrangement gear 55 may be disposed on the upper surface of the frame 61 such that the center of the arrangement gear 55 coincides with the center of the rotation shaft 65.

Two arrangement gears 55 (e.g., a first arrangement gear and a second arrangement gear) of two finger modules 10 (e.g., a first finger module and a second finger module) connected by the connecting part 80A may be disposed on two frames 61 (e.g., a first frame and a second frame) so as to mesh with each other. For example, when the first arrangement motor 50 of the first finger module 10 operates and the first housing 60 to which the first arrangement motor 50 is fixed rotates about the first arrangement motor shaft 51, the first housing 60 may rotate along the second arrangement gear 55 disposed in the second housing 60 of another finger module 10 (i.e., the second finger module) with which the first arrangement gear 55 is meshed.

The cover 62 may be disposed on the frame 61. The cover 62 may be disposed on the outside of the frame 61 to cover the arrangement motor 50, the finger motor 40, and the power transmission device 30 disposed on the frame 61. Therefore, the arrangement motor 50, the finger motor 40, and the power transmission device 30 disposed in the frame 61 may not be exposed to the outside.

The housing 60 may further include a motor driver 110. The motor driver 110 may be disposed in the housing 60 and configured to control the finger motor 40 and the arrangement motor 50. The motor driver 110 may be disposed in the frame 61. The cover 62 may be configured to cover the motor driver 110. Therefore, the motor driver 110 may not be exposed to the outside of the housing 60.

The housing 60 may further include a support block 12. The support block 12 may be formed to support a cylindrical object when the finger 20 grasps the cylindrical object. To this end, the support block 12 may include an inclined surface 12a. The support block 12 may be disposed on the upper surface of the housing 60, i.e., the upper surface of the frame 61. The support block 12 may be disposed on the upper surface of the frame 61 such that the inclined surface 12a is positioned above the rotation shaft 65.

The housing 60 may further inclined a limit sensor 131. The limit sensor 131 may be configured to limit the movement of the moving plate 343. The rotating angle of the finger 20 may be limited by the limit sensor 131. The limit sensor 131 may be disposed on the frame 61 so as to detect a detection piece installed on the moving plate 343. The limit sensor 131 may be disposed adjacent to the ball screw 341 below the upper frame 61a. For example, a PI (photo interrupter) sensor may be used as the limit sensor 131.

The housing 60 may further include an arrangement sensor 133. The arrangement sensor 133 may be disposed to limit the rotation of the housing 60. The rotation angle of the finger module 10 may be limited by the arrangement sensor 133. For example, a Hall sensor may be used as the arrangement sensor 133. The Hall sensor 133 may be disposed on the lower connecting link 90 to which the arrangement motor shaft 51 is fixed, and a magnet 134 may be disposed in the frame 61. The Hall sensor 133 may be disposed on the lower connecting link 90 to detect the magnet 134 installed in the frame 61.

The robot hand 1 may include a hand processor 120. The hand processor 120 may be configured to control the motor driver 110. The hand processor 120 may be disposed in the base 100. The hand processor 120 may be configured to receive signals from the limit sensor 131 and the arrangement sensor 133 and control the motor driver 110.

In some embodiments, the finger module 10 may include a finger sensor. When the finger module 10 includes a finger sensor, the hand processor 120 may be configured to receive signals from the finger sensor and control the motor driver 110. The finger sensor may include various types of sensors, such as a force-torque sensor (FT sensor), a tactile sensor, a photo sensor, etc. For example, the finger sensor may be disposed in the finger tip 11 of the finger module 10.

Hereinafter, the connecting part 80A of a robot hand 1 according to one or more embodiments of the disclosure will be described in detail with reference to FIGS. 2, 4, 8, and 9.

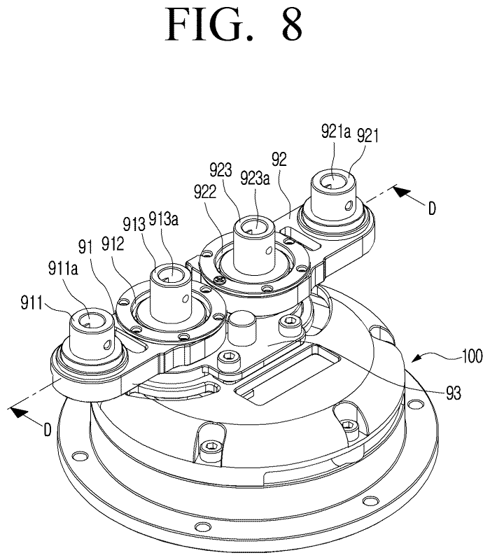

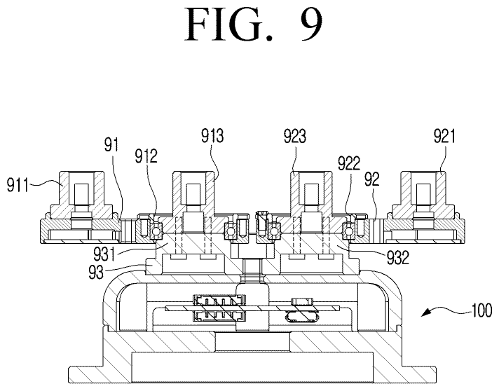

FIG. 8 is a perspective view illustrating a lower connecting link 90 of a robot hand 1 according to one or more embodiments of the disclosure. FIG. 9 is a cross-sectional view illustrating the lower connecting link 90 of the robot hand 1 according to one or more embodiments of the disclosure taken along line D-D of FIG. 8.

The connecting part 80A may be configured to rotatably connect two finger modules 10. The connecting part 80A may include an upper connecting link 80 and a lower connecting link 90.

The upper connecting link 80 may be configured to connect and rotatably support two rotation shafts 65 of two adjacent finger modules 10.

Referring to FIGS. 2 and 4, the upper connecting link 80 may include a first upper connecting link 81 and a second upper connecting link 82.

The first upper connecting link 81 may include a first connecting hole 811 and a second connecting hole 812 formed at both ends thereof. The rotation shaft 65 of the first finger module 10-1 may be inserted into the first connecting hole 811. A bearing may be disposed between the first connecting hole 811 and the rotation shaft 65 of the first finger module 10-1. The rotation shaft 65 of the second finger module 10-2 may be inserted into the second connecting hole 812. A bearing may be disposed between the second connecting hole 812 and the rotation shaft 65 of the second finger module 10-2.

When the rotation shaft 65 of the first finger module 10-1 and the rotation shaft 65 of the second finger module 10-2 are connected by the first upper connecting link 81, the arrangement gear 55 of the first finger module 10-1 and the arrangement gear 55 of the second finger module 10-2 may mesh with each other. Therefore, the first finger module 10-1 and the second finger module 10-2 may rotate with respect to each other.

The second upper connecting link 82 may be configured in the same manner as the first upper connecting link 81. Therefore, the second upper connecting link 82 may include a third connecting hole 821 and a fourth connecting hole 822 formed at both ends thereof. The rotation shaft 65 of the third finger module 10-3 may be inserted into the third connecting hole 821. A bearing may be disposed between the third connecting hole 821 and the rotation shaft 65 of the third finger module 10-3. The rotation shaft 65 of the fourth finger module 10-4 may be inserted into the fourth connecting hole 822. A bearing may be disposed between the fourth connecting hole 822 and the rotation shaft 65 of the fourth finger module 10-4.

When the rotation shaft 65 of the third finger module 10-3 and the rotation shaft 65 of the fourth finger module 10-4 are connected by the second upper connecting link 82, the arrangement gear 55 of the third finger module 10-3 and the arrangement gear 55 of the fourth finger module 10-4 may mesh with each other. Therefore, the third finger module 10-3 and the fourth finger module 10-4 may rotate with respect to each other.

The upper connecting link 80 may further include an upper holding link 83 configured to connect the first upper connecting link 81 and the second upper connecting link 82. The upper holding link 83 may be configured to allow the first upper connecting link 81 and the second upper connecting link 82 to rotate while maintaining a certain distance from each other.

One end of the upper holding link 83 may be rotatably connected to the other end of the first upper connecting link 81, and the other end of the upper holding link 83 may be rotatably connected to one end of the second upper connecting link 82. Because the rotation shaft 65 of the second finger module 10-2 is rotatably disposed at the other end of the first upper connecting link 81, one end of the upper holding link 83 may be rotatably connected to the rotation shaft 65 of the second finger module 10-2. Because the rotation shaft 65 of the third finger module 10-3 is rotatably disposed at one end of the second upper connecting link 82, the other end of the upper holding link 83 may be rotatably connected to the rotation shaft 65 of the third finger module 10-3.

For example, the upper holding link 83 may include a first holding hole 831 formed at one end thereof and a second holding hole 832 formed at the other end thereof. A first holding shaft 833 coaxially disposed to the rotation shaft 65 of the second finger module 10-2 may be rotatably disposed in the first holding hole 831. A bearing may be disposed between the first holding hole 831 and the first holding shaft 833. A second holding shaft 834 coaxially disposed to the rotation shaft 65 of the third finger module 10-3 may be rotatably disposed in the second holding hole 832. A bearing may be disposed between the second holding hole 832 and the second holding shaft 834.

In this case, the arrangement gear 55 of the second finger module 10-2 and the arrangement gear 55 of the third finger module 10-3 may not mesh with each other. Therefore, the second finger module 10-2 may independently rotate about the arrangement motor shaft 51 and the rotation shaft 65 of the second finger module 10-2 regardless of the third finger module 10-3. In addition, the third finger module 10-3 may independently rotate about the arrangement motor shaft 51 and the rotation shaft 65 of the third finger module 10-3 regardless of the second finger module 10-2. The gap between the second finger module 10-2 and the third finger module 10-3 may be maintained by the upper holding link 83.

The upper connecting link 80, that is, the first upper connecting link 81, the second upper connecting link 82, and the upper holding link 83, may be disposed on the upper side of the housing 60 and below the support block 12.

The lower connecting link 90 may be configured to connect and support two arrangement motor shafts 51 of two adjacent finger modules 10.

Referring to FIGS. 2, 4, 8, and 9, the lower connecting link 90 may include a first lower connecting link 91 and a second lower connecting link 92.

The first lower connecting link 91 may include a first fixed boss 911 formed at one end thereof and a first holding hole 912 formed at the other end thereof. The arrangement motor shaft 51 of the first finger module 10-1 may be inserted and fixed into a fixing groove 911a of the first fixed boss 911. A first holding boss 913 may be rotatably disposed in the first holding hole 912. A bearing may be disposed between the first holding hole 912 and the first holding boss 913. Therefore, the first lower connecting link 91 may rotate about the first holding boss 913.

The arrangement motor shaft 51 of the second finger module 10-2 may be inserted and fixed into the fixing groove 913a of the first holding boss 913. Because the arrangement motor shaft 51 of the first finger module 10-1 is fixed to the first fixed boss 911 of the first lower connecting link 91, the first finger module 10-1 may freely rotate about the first holding boss 913.

The second lower connecting link 92 may be configured in the same manner as the first lower connecting link 91. The second lower connecting link 92 may include a second fixed boss 921 formed at one end thereof and a second holding hole 922 formed at the other end thereof. The arrangement motor shaft 51 of the fourth finger module 10-4 may be inserted and fixed into a fixing groove 921a of the second fixed boss 921. A second holding boss 923 may be rotatably disposed in the second holding hole 922. A bearing may be disposed between the second holding hole 922 and the second holding boss 923. Therefore, the second lower connecting link 92 may rotate about the second holding boss 923.

The arrangement motor shaft 51 of the third finger module 10-3 may be inserted and fixed into the fixing groove 923a of the second holding boss 923. Because the arrangement motor shaft 51 of the fourth finger module 10-4 is fixed to the second fixed boss 921 of the second lower connecting link 92, the fourth finger module 10-4 may freely rotate about the second holding boss 923.

When the arrangement motor shaft 51 of the first finger module 10-1 and the arrangement motor shaft 51 of the second finger module 10-2 are connected by the first lower connecting link 91 and the rotation shaft 65 of the first finger module 10-1 and the rotation shaft 65 of the second finger module 10-2 are connected by the first upper connecting link 81, the arrangement gear 55 of the first finger module 10-1 and the arrangement gear 55 of the second finger module 10-2 may mesh with each other. Therefore, the first finger module 10-1 and the second finger module 10-2 may rotate with respect to each other.

When the arrangement motor shaft 51 of the third finger module 10-3 and the arrangement motor shaft 51 of the fourth finger module 10-4 are connected by the second lower connecting link 92 and the rotation shaft 65 of the third finger module 10-3 and the rotation shaft 65 of the fourth finger module 10-4 are connected by the second upper connecting link 82, the arrangement gear 55 of the third finger module 10-3 and the arrangement gear 55 of the fourth finger module 10-4 may mesh with each other. Therefore, the third finger module 10-3 and the fourth finger module 10-4 may rotate with respect to each other.

The lower holding link 93 may be disposed below the first lower connecting link 91 and the second lower connecting link 92. The lower holding link 93 may be configured to rotatably connect the other end of the first lower connecting link 91 and one end of the second lower connecting link 92.

For example, the lower holding link 93 may be configured to rotatably connect the first holding hole 912 of the first lower connecting link 91 and the second holding hole 922 of the second lower connecting link 92. A first holding protrusion 931, which is inserted into the first holding hole 912 of the first lower connecting link 91 and supported by a bearing, may be formed at one end of the lower holding link 93. The first holding boss 913 may be fixed to the upper surface of the first holding protrusion 931. Therefore, the first lower connecting link 91 may freely rotate about the first holding boss 913 and the first holding protrusion 931.

A second holding protrusion 932, which is inserted into the second holding hole 922 of the second lower connecting link 92 and supported by a bearing, may be formed at the other end of the lower holding link 93. The second holding boss 923 may be fixed to the upper surface of the second holding protrusion 932. Therefore, the second lower connecting link 92 may freely rotate about the second holding boss 923 and the second holding protrusion 932.

Accordingly, the first lower connecting link 91 and the second lower connecting link 92 may be supported by the lower holding link 93 and may freely rotate relative to the lower holding link 93.

The connecting part 80A may include a base 100 that supports the lower connecting link 90. The base 100 may be provided below the lower connecting link 90. When the two lower connecting links 91 and 92 are supported by the lower holding link 93, the base 100 may be disposed beneath the lower holding link 93. In other words, the lower holding link 93 may be disposed on the upper surface of the base 100.

The base 100 may be configured to allow the robot hand 1 according to one or more embodiments of the disclosure to be disposed on a robot arm 200. The lower surface of the base 100 may be configured to correspond to the leading end of the robot arm 200 on which the robot hand 1 according to one or more embodiments of the disclosure is to be disposed.

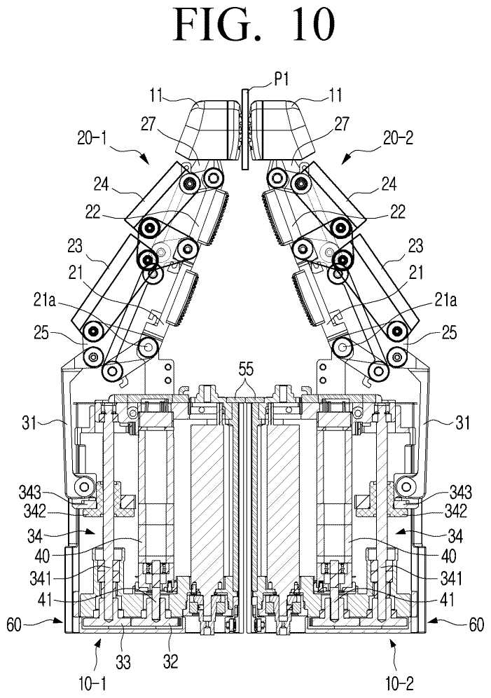

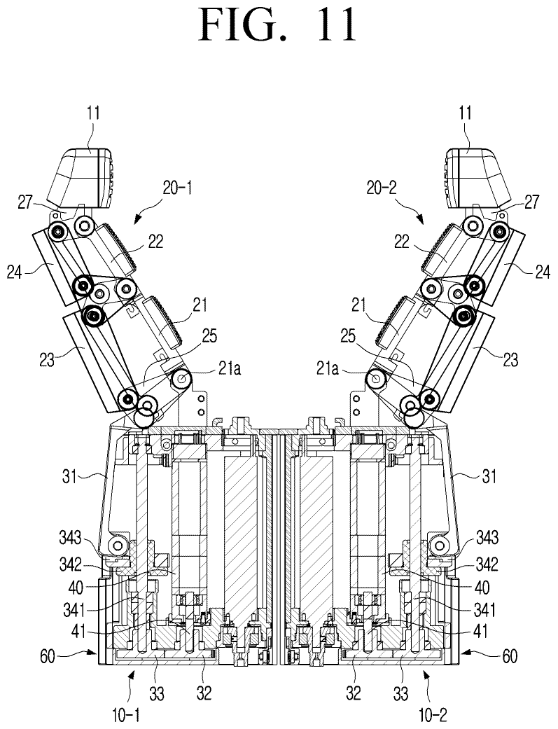

Hereinafter, with reference to FIGS. 10 and 11, the operation of the finger part 20A when a robot hand 1 according to one or more embodiments of the disclosure takes an object will be described in detail.

FIG. 10 is a cross-sectional view illustrating a state in which finger tips of two finger modules of a robot hand 1 according to one or more embodiments of the disclosure have picked up an object.

Referring to FIG. 10, an object, such as a thin, flat-plate-shaped object P1 may be picked up by two fingers 20, that is, the finger tip 11 of the first finger 20-1 and the finger tip 11 of the second finger 20-2.

Initially, the finger 20-1 of the first finger module 10-1 (hereinafter, the first finger) and the finger 20-2 of the second finger module 10-2 (hereinafter, the second finger) may be positioned approximately vertically with respect to the upper surface of the housing 60 as illustrated in FIG. 7. In this state, the finger motor 40 of the first finger module 10-1 and the finger motor 40 of the second finger module 10-2 may be operated simultaneously.

When the finger motor shaft 41 of the finger motor 40 of the first finger module 10-1 rotates in one direction (for example, clockwise), the pinion 32 may rotate integrally with the finger motor shaft 41. When the pinion 32 rotates, the transmission gear 33 may rotate and the power conversion mechanism 34 may raise the connecting rod 31. For example, when the transmission gear 33 rotates, the ball screw 341 on which the transmission gear 33 is disposed may rotate in one direction. When the ball screw 341 rotates in one direction, the ball nut 342 screwed to the ball screw 341 may rise along the ball screw 341. When the ball nut 342 rises, the moving plate 343 disposed on the ball nut 342 may rise. Accordingly, the connecting rod 31 connected to the moving plate 343 may rise.

When the connecting rod 31 rises, the first ternary link 25 connected to the one end of the connecting rod 31 may rotate clockwise by a certain angle about the first hinge shaft 21a.

When the first ternary link 25 rotates clockwise at a certain angle, the first finger 20-1 may rotate at a certain angle in the inward direction ID, i.e., toward the second finger 20-2 about the first hinge shaft 21a. For example, the first inner link 21, the second inner link 22, the first outer link 23, and the second outer link 24 of the first finger 20-1 may all move in the inward direction ID about the first hinge shaft 21a. At this time, the finger tip 11 disposed on the tip link 27 connected to the other end of the second inner link 22 and the other end of the second outer link 24 of the first finger 20-1 may remain approximately vertical with respect to the upper surface of the housing 60.

The second finger 20-2 of the second finger module 10-2 may be arranged symmetrically with the first finger 20-1 of the first finger module 10-1. The second finger 20-2 may operate in the same manner as the first finger 20-1 described above. For example, when the finger motor 40 of the second finger module 10-2 operates, the finger motor shaft 41 of the second finger module 10-2 may rotate, causing the connecting rod 31 of the second finger module 10-2 to rise.

Then, the second finger 20-2 may rotate at a certain angle in the inward direction ID, i.e., toward the first finger 20-1 about the first hinge shaft 21a. For example, the first inner link 21, the second inner link 22, the first outer link 23, and the second outer link 24 of the second finger 20-2 may all move in the inward direction ID about the first hinge shaft 21a.

At this time, the finger tip 11 disposed on the tip link 27 connected to the other end of the second inner link 22 and the other end of the second outer link 24 of the second finger 20-2 may remain approximately perpendicular to the upper surface of the housing 60. Therefore, the finger tip 11 of the first finger 20-1 and the finger tip 11 of the second finger 20-2 may pick up the object P1 located between them.

When the finger motor 40 of the first finger 20-1 and the finger motor 40 of the second finger module 10-2 are rotated in opposite direction (e.g., counterclockwise), the finger tip 11 of the first finger module 10-1 and the finger tip 11 of the second finger module 10-2 may be spread apart. The spread-apart state of the finger tip 11 of the first finger module 10-1 and the finger tip 11 of the second finger module 10-2 is illustrated in FIG. 11.

FIG. 11 is a cross-sectional view illustrating a state in which fingers of two finger modules of a robot hand 1 according to one or more embodiments of the disclosure are maximally spread apart.

In the state of FIG. 10, the finger motor shaft 41 of the first finger module 10-1 and the finger motor shaft 41 of the second finger module 10-2 may be simultaneously rotated in opposite directions (e.g., counterclockwise).

When the finger motor shaft 41 of the finger motor 40 of the first finger module 10-1 rotates in the opposite direction, the pinion 32 may rotate integrally with the finger motor shaft 41. When the pinion 32 rotates, the transmission gear 33 may rotate and the power conversion mechanism 34 may lower the connecting rod 31. For example, when the transmission gear 33 rotates, the ball screw 341 on which the transmission gear 33 is disposed may rotate in the opposite direction. When the ball screw 341 rotates in the opposite direction, the ball nut 342 screwed to the ball screw 341 may descend along the ball screw 341. When the ball nut 342 descends, the moving plate 343 disposed on the ball nut 342 may descend. Accordingly, the connecting rod 31 connected to the moving plate 343 may be lowered.

When the connecting rod 31 is lowered, the first ternary link 25 connected to one end of the connecting rod 31 may rotate counterclockwise by a certain angle about the first hinge shaft 21a.

When the first ternary link 25 rotates counterclockwise by a certain angle, the first finger 20-1 may rotate by a certain angle in the outward direction OD, i.e., in the direction away from the second finger 20-2 about the first hinge shaft 21a. For example, the first inner link 21, the second inner link 22, the first outer link 23, and the second outer link 24 of the first finger 20-1 may all move in the outward direction OD about the first hinge shaft 21a. At this time, the finger tip 11 disposed on the tip link 27 connected to the other end of the second inner link 22 and the other end of the second outer link 24 of the first finger 20-1 may remain approximately perpendicular to the upper surface of the housing 60.

The second finger 20-2 may operate in the same manner as the first finger module 10-1 described above. For example, when the finger motor shaft 41 of the finger motor 40 of the second finger module 10-2 rotates in the opposite direction, the connecting rod 31 of the second finger module 10-2 may descend. Then, the second finger 20-2 may rotate at a certain angle in the outward direction OD, i.e., in a direction away from the first finger 20-1 about the first hinge shaft 21a. For example, the first inner link 21, the second inner link 22, the first outer link 23, and the second outer link 24 of the second finger 20-2 may all move in the outward direction OD about the first hinge shaft 21a. At this time, the finger tip 11 disposed on the tip link 27 connected to the other end of the second inner link 22 and the other end of the second outer link 24 of the second finger 20-2 may remain approximately perpendicular to the upper surface of the housing 60.

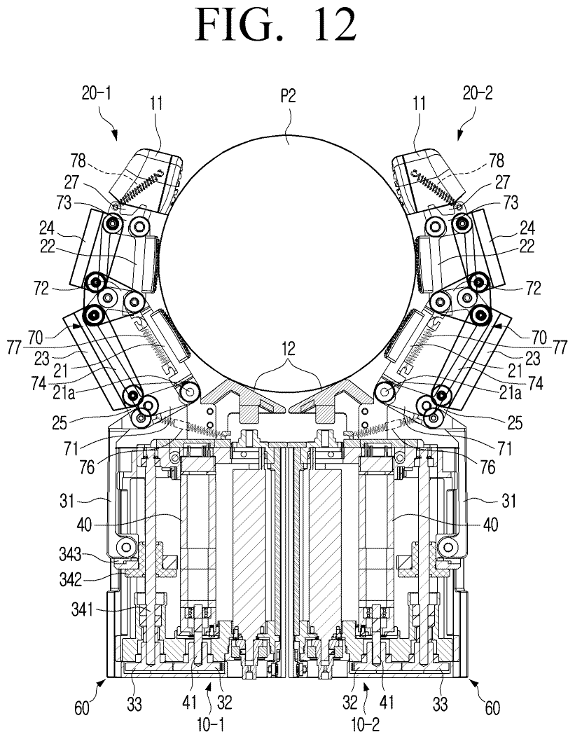

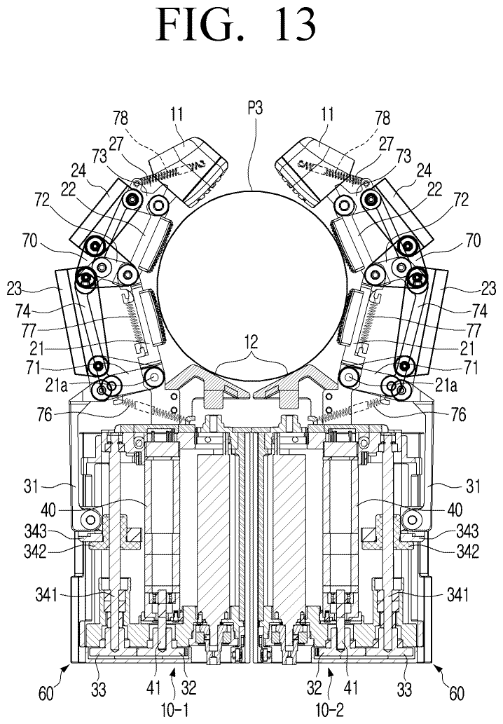

The robot hand 1 according to one or more embodiments of the disclosure may grasp an object having an approximately cylindrical shape (hereinafter, referred to as a cylindrical object) using the passive adaptation mechanism 70 as illustrated in FIGS. 12 and 13.

FIG. 12 is a cross-sectional view illustrating a state in which a robot hand 1 according to one or more embodiments of the disclosure grasps a cylindrical object.

Referring to FIG. 12, the robot hand 1 according to one or more embodiments of the disclosure may grasp a cylindrical object P2 using the first inner links 21 and the second inner links 22 of two fingers 20. For example, the cylindrical object may be grasped between the first inner link 21 and the second inner link 22 of the first finger 20-1 and the first inner link 21 and the second inner link 22 of the second finger 20-2.

In the state of FIG. 11, after the cylindrical object is brought into contact with the inclined surfaces 12a of the support blocks 12, the finger motor 40 of the first finger module 10-1 and the finger motor 40 of the second finger module 10-2 are operated simultaneously.

When the finger motor shaft 41 of the first finger module 10-1 rotates in one direction (e.g., clockwise), the pinion 32 may rotate integrally with the finger motor shaft 41. When the pinion 32 rotates, the transmission gear 33 may rotate and the power conversion mechanism 34 may raise the connecting rod 31. For example, when the transmission gear 33 rotates, the ball screw 341 on which the transmission gear 33 is disposed may rotate in one direction. When the ball screw 341 rotates in one direction, the ball nut 342 screwed to the ball screw 341 may rise along the ball screw 341. When the ball nut 342 rises, the moving plate 343 disposed on the ball nut 342 may rise. Accordingly, the connecting rod 31 connected to the moving plate 343 may rise.

When the connecting rod 31 rises, the first ternary link 25 connected to one end of the connecting rod 31 may rotate clockwise by a certain angle about the first hinge shaft 21a.

When the first ternary link 25 rotates clockwise by a certain angle, the first finger 20-1 may rotate at a certain angle in the inward direction ID, i.e., toward the second finger 20-2 about the first hinge shaft 21a. For example, the first inner link 21, the second inner link 22, the first outer link 23, and the second outer link 24 of the first finger 20-1 may all move in the inward direction ID about the first hinge shaft 21a. Accordingly, the first inner link 21 and the second inner link 22 of the first finger 20-1 may come into contact with the cylindrical object P2.

When the first inner link 21 and the second inner link 22 of the first finger 20-1 come into contact with the cylindrical object and do not move any further, the first inner link 21 and the second inner link 22 may apply force to the cylindrical object P2 by a plurality of springs of the passive adaptation mechanism 70 disposed at the rear of the first inner link 21 and the second inner link 22. For example, the first inner link 21 and the second inner link 22 of the first finger 20-1 may apply force to the cylindrical object P2 by the first spring 76 connecting the first passive link 71 of the passive adaptation mechanism 70 and the frame 61, the second spring 77 connecting the first inner link 21 and the second inner link 22, and the third spring 78 connecting the third passive link 73 and the tip link 27.

At this time, the finger tip 11 disposed on the tip link 27 connected to the other end of the second inner link 22 and the other end of the second outer link 24 of the first finger 20-1 may be adjacent to the outer circumferential surface of the cylindrical object P2.

The second finger 20-2 may operate in the same manner as the first finger 20-1 described above. For example, when the finger motor shaft 41 of the finger motor 40 of the second finger module 10-2 rotates in one direction, the connecting rod 31 of the second finger module 10-2 may rise. Then, the second finger 20-2 may rotate at a certain angle in the inward direction ID, i.e., in a direction approaching the first finger 20-1, about the first hinge shaft 21a. For example, the first inner link 21, the second inner link 22, the first outer link 23, and the second outer link 24 of the second finger 20-2 may all move in the inward direction ID about the first hinge shaft 21a. Therefore, the first inner link 21 and the second inner link 22 of the second finger 20-2 may come into contact with the cylindrical object P2.

When the first inner link 21 and the second inner link 22 of the second finger 20-2 come into contact with the cylindrical object P2 and do not move any further, the first inner link 21 and the second inner link 22 may apply force to the cylindrical object P2 by a plurality of springs of the passive adaptation mechanism 70 disposed at the rear of the first inner link 21 and the second inner link 22. For example, the first inner link 21 and the second inner link 22 of the second finger 20-2 may apply force to the cylindrical object P2 by the first spring 76 connecting the first passive link 71 of the passive adaptation mechanism 70 of the second finger 20-2 and the frame 61, the second spring 77 connecting the first inner link 21 and the second inner link 22, and the third spring 78 connecting the third passive link 73 and the tip link 27.

At this time, the finger tip 11 disposed on the tip link 27 connected to the other end of the second inner link 22 and the other end of the second outer link 24 of the second finger 20-2 may be adjacent to the outer circumferential surface of the cylindrical object P2.

Accordingly, the cylindrical object P2 positioned between the first finger 20-1 and the second finger 20-2 may be firmly grasped by the first and second inner links 21 and 22 of the first finger 20-1 and the first and second inner links 21 and 22 of the second finger 20-2.

When the diameter of the cylindrical object is small, the finger tip 11 of the first finger 20-1 and the finger tip 11 of the second finger 20-2 may be positioned above the cylindrical object P3, as illustrated in FIG. 13.

FIG. 13 is a cross-sectional view illustrating a state in which a robot hand 1 according to one or more embodiments of the disclosure grasps a cylindrical object.

Referring to FIG. 13, the robot hand 1 according to one or more embodiments of the disclosure may grasp a cylindrical object P3 using the first inner links 21 and the second inner links 22 of two fingers 20. For example, the cylindrical object P3 may be grasped between the first inner link 21 and the second inner link 22 of the first finger 20-1 and the first inner link 21 and the second inner link 22 of the second finger 20-2.

Accordingly, the robot hand 1 of FIG. 13 may operate in the same manner as the robot hand 1 of FIG. 12 described above. However, because the diameter of the cylindrical object P3 is smaller than the diameter of the cylindrical object P2 of FIG. 12, the first ternary link 25 of the first finger 20-1 may rotate more clockwise than the first ternary link 25 of the first finger 20-1 of FIG. 12, so that the finger tip 11 disposed on the tip link 27 may be positioned above the cylindrical object P3. The first ternary link 25 of the second finger 20-2 may rotate more counterclockwise than the first ternary link 25 of the second finger 20-2 of FIG. 12, so that the finger tip 11 disposed on the tip link 27 may be positioned above the cylindrical object P3.

Accordingly, the cylindrical object P3 having a small diameter positioned between the first finger 20-1 and the second finger 20-2 may be firmly grasped by the first inner link 21, the second inner link 22, and the finger tip 11 of the first finger 20-1 and the first inner link 21, the second inner link 22, and the finger tip 11 of the second finger 20-2.

The robot hand 1 according to one or more embodiments of the disclosure may be configured to take objects of various shapes by changing the arrangement of the plurality of finger modules 10.

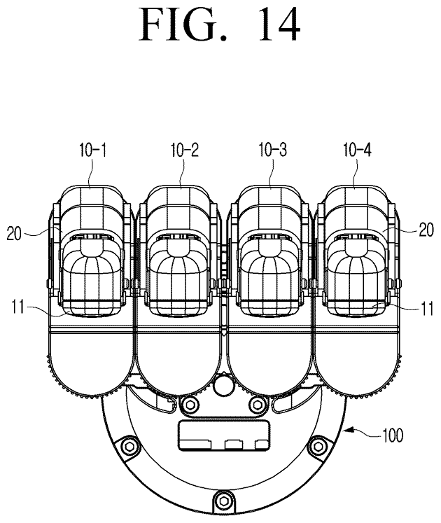

Hereinafter, various arrangement modes of the finger modules 10 of the robot hand 1 according to one or more embodiments of the disclosure having four finger modules 10 will be described in detail with reference to FIGS. 14, 15, 16, 17, and 18.

FIG. 14 is a plan view illustrating a case in which four finger modules 10 of a robot hand 1 according to one or more embodiments of the disclosure are in a basic mode.

Referring to FIG. 14, in a basic mode, four finger modules 10, i.e., the first finger module 10-1, the second finger module 10-2, the third finger module 10-3, and the fourth finger module 10-4, may all be arranged in parallel with their finger tips 11 all facing the same direction. Therefore, in the basic mode, the robot hand 1 according to one or more embodiments of the disclosure may not take an object. However, the robot hand 1 may perform various operations by operating the plurality of fingers 20.

In this state, the arrangement motors 50 of the four finger modules 10 may be controlled to change the arrangement mode of the four finger modules 10.

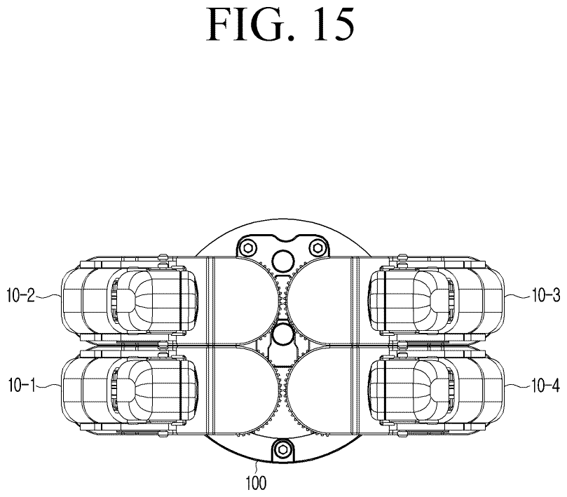

FIG. 15 is a plan view illustrating a case in which four finger modules 10 of a robot hand 1 according to one or more embodiments of the disclosure are in a first mode.

From the basic mode of FIG. 14, by operating the arrangement motor 50 of the second finger module 10-2 to rotate the second finger module 10-2 90 degrees counterclockwise and operating the arrangement motor 50 of the third finger module 10-3 to rotate the third finger module 10-3 90 degrees clockwise, the first finger module 10-1, the second finger module 10-2, the third finger module 10-3, and the fourth finger module 10-4 may be arranged in the first mode illustrated in FIG. 15.

In the first mode, the first finger module 10-1 and the second finger module 10-2 may be arranged adjacent and parallel to each other, and face the third finger module 10-3 and the fourth finger module 10-4 that are arranged adjacent and parallel to each other. For example, the first finger module 10-1 may face the fourth finger module 10-4, and the second finger module 10-2 may face the third finger module 10-3.

The arrangement motor shaft 51 of the second finger module 10-2 may be fixed to the first holding boss 913 of the first lower connecting link 91, and the arrangement motor shaft 51 of the first finger module 10-1 may be fixed to the first fixed boss 911 of the first lower connecting link 91. Accordingly, when the arrangement motor shaft 51 of the second finger module 10-2 rotates, the housing 60 of the second finger module 10-2 may rotate about the arrangement motor shaft 51 and the rotation shaft 65 of the second finger module 10-2, so that the first finger module 10-1 connected to the second finger module 10-2 by the first lower connecting link 91 may rotate integrally with the second finger module 10-2. Accordingly, when the second finger module 10-2 rotates 90 degrees counterclockwise by the arrangement motor 50 of the second finger module 10-2, the first finger module 10-1 may rotate 90 degrees counterclockwise together with the second finger module 10-2.

At this time, because the rotation shaft 65 of the second finger module 10-2 and the rotation shaft 65 of the first finger module 10-1 are rotatably connected by the first upper connecting link 81, the first finger module 10-1 and the second finger module 10-2 may rotate stably.

The arrangement motor shaft 51 of the third finger module 10-3 may be fixed to the second holding boss 923 of the second lower connecting link 92, and the arrangement motor shaft 51 of the fourth finger module 10-4 may be fixed to the second fixed boss 921 of the second lower connecting link 92. Accordingly, when the arrangement motor shaft 51 of the third finger module 10-3 rotates, the housing 60 of the third finger module 10-3 may rotate about the arrangement motor shaft 51 and the rotation shaft 65, so that the fourth finger module 10-4 connected to the third finger module 10-3 by the second lower connecting link 92 may rotate integrally with the third finger module 10-3. Accordingly, when the third finger module 10-3 rotates 90 degrees clockwise by the arrangement motor 50 of the third finger module 10-3, the fourth finger module 10-4 may rotate 90 degrees clockwise together with the third finger module 10-3.

At this time, because the rotation shaft 65 of the third finger module 10-3 and the rotation shaft 65 of the fourth finger module 10-4 are rotatably connected by the second upper connecting link 82 the third finger module 10-3 and the fourth finger module 10-4 may rotate stably.

Due to the rotational connection of the second finger module 10-2 and the third finger module 10-3 via the upper holding link 83, the first and second finger modules 10-1 and 10-2 may rotate stably with respect to the third and fourth finger modules 10-3 and 10-4, and vice versa.

For example, when four finger modules 10 are in the first mode, the robot hand 1 may pick up an object having a roughly rectangular parallelepiped shape using the finger tips 11 of the four finger modules 10. In some embodiments, the robot hand 1 may pick up a small part, a thin part, etc. using two facing finger modules 10 among the four finger modules 10. Alternatively, the robot hand 1 may remove tape or assemble connectors.

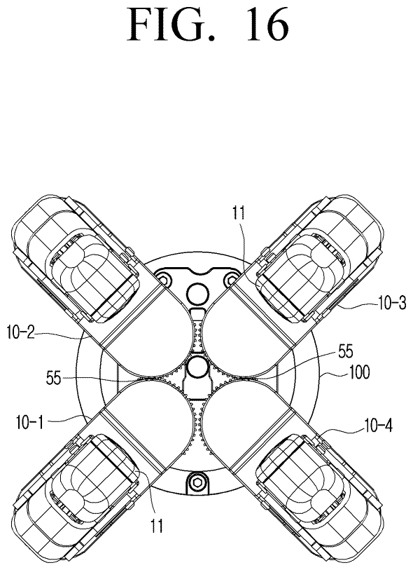

FIG. 16 is a plan view illustrating a case in which four finger modules 10 of a robot hand 1 according to one or more embodiments of the disclosure are in a second mode.

From the basic mode of FIG. 14, when the arrangement motor 50 of the second finger module 10-2 is operated to rotate the second finger module 10-2 90 degrees counterclockwise and the arrangement motor 50 of the first finger module 10-1 is operated to rotate the first finger module 10-1 45 degrees counterclockwise, the first finger module 10-1 and the second finger module 10-2 may be arranged at 90 degrees with respect to each other as illustrated in FIG. 16. The first finger module 10-1 and the second finger module 10-2 are meshed with each other by the arrangement gear 55 of the housing 60, so that when the first finger module 10-1 rotates 45 degrees counterclockwise, the second finger module 10-2 may rotate 45 degrees clockwise. Accordingly, the angle between the first finger module 10-1 and the second finger module 10-2 may be 90 degrees.

In addition, when the arrangement motor 50 of the third finger module 10-3 is operated to rotate the third finger module 10-3 90 degrees clockwise and the arrangement motor 50 of the fourth finger module 10-4 is operated to rotate the fourth finger module 10-4 45 degrees clockwise, the third finger module 10-3 and the fourth finger module 10-4 may be arranged at 90 degrees as illustrated in FIG. 16. The third finger module 10-3 and the fourth finger module 10-4 are meshed with each other by the arrangement gear 55 of the housing 60, so that when the fourth finger module 10-4 rotates 45 degrees clockwise, the third finger module 10-3 may rotate 45 degrees counterclockwise. Accordingly, the angle between the third finger module 10-3 and the fourth finger module 10-4 may be 90 degrees.

Therefore, the first finger module 10-1, the second finger module 10-2, the third finger module 10-3, and the fourth finger module 10-4 may be arranged in the second mode as illustrated in FIG. 16.

In the second mode, the first finger module 10-1, the second finger module 10-2, the third finger module 10-3, and the fourth finger module 10-4 may be arranged in a cross shape. For example, the first finger module 10-1 may form a 90-degree angle with the second finger module 10-2 and the fourth finger module 10-4, and may face the third finger module 10-3. The second finger module 10-2 may form a 90-degree angle with the first finger module 10-1 and the third finger module 10-3, and may face the fourth finger module 10-4. The third finger module 10-3 may form a 90-degree angle with the second finger module 10-2 and the fourth finger module 10-4, and may face the first finger module 10-1. The fourth finger module 10-4 may form a 90-degree angle with the first finger module 10-1 and the third finger module 10-3, and may face the second finger module 10-2.

The arrangement motor shaft 51 of the second finger module 10-2 may be fixed to the first holding boss 913 of the first lower connecting link 91, and the arrangement motor shaft 51 of the first finger module 10-1 may be fixed to the first fixed boss 911 of the first lower connecting link 91. Accordingly, when the arrangement motor shaft 51 of the second finger module 10-2 rotates, the housing 60 of the second finger module 10-2 may rotate about the arrangement motor shaft 51 and the rotation shaft 65, so that the first finger module 10-1 connected to the second finger module 10-2 by the first lower connecting link 91 may rotate integrally with the second finger module 10-2. Accordingly, when the second finger module 10-2 is rotated 90 degrees counterclockwise by the arrangement motor 50 of the second finger module 10-2, the first finger module 10-1 may be rotated 90 degrees counterclockwise together with the second finger module 10-2.

In this state, when the first finger module 10-1 is rotated 45 degrees counterclockwise by the arrangement motor 50 of the first finger module 10-1, the second finger module 10-2 may be rotated 45 degrees clockwise, so that the first finger module 10-1 and the second finger module 10-2 may be arranged apart at 90 degrees. Because the first finger module 10-1 and the second finger module 10-2 are meshed with each other by the arrangement gear 55 of the housing 60, when the first finger module 10-1 is rotated 45 degrees counterclockwise, the second finger module 10-2 may be rotated 45 degrees clockwise. Accordingly, the angle between the first finger module 10-1 and the second finger module 10-2 may be 90 degrees.

The arrangement motor shaft 51 of the third finger module 10-3 may be fixed to the second holding boss 923 of the second lower connecting link 92, and the arrangement motor shaft 51 of the fourth finger module 10-4 may be fixed to the second fixed boss 921 of the second lower connecting link 92. Accordingly, when the arrangement motor shaft 51 of the third finger module 10-3 rotates, the housing 60 of the third finger module 10-3 may rotate about the arrangement motor shaft 51 and the rotation shaft 65, so that the fourth finger module 10-4 connected to the third finger module 10-3 by the second lower connecting link 92 may rotate integrally with the third finger module 10-3. Accordingly, when the third finger module 10-3 is rotated 90 degrees clockwise by the arrangement motor 50 of the third finger module 10-3, the fourth finger module 10-4 may be rotated 90 degrees clockwise together with the third finger module 10-3.

In this state, when the fourth finger module 10-4 is rotated 45 degrees clockwise by the arrangement motor 50 of the fourth finger module 10-4, the third finger module 10-3 may be rotated 45 degrees counterclockwise, so that the third finger module 10-3 and the fourth finger module 10-4 may be arranged at an angle of 90 degrees. Because the third finger module 10-3 and the fourth finger module 10-4 are meshed with each other by the arrangement gear 55 of the housing 60, when the fourth finger module 10-4 is rotated 45 degrees clockwise, the third finger module 10-3 may be rotated 45 degrees counterclockwise. Accordingly, the angle between the third finger module 10-3 and the fourth finger module 10-4 may be 90 degrees.

The four finger modules 10 may be converted from the first mode illustrated in FIG. 15 to the second mode illustrated in FIG. 16. For example, from the first mode, when the first finger module 10-1 is rotated 45 degrees counterclockwise and the fourth finger module 10-4 is rotated 45 degrees clockwise, the first finger module 10-1, the second finger module 10-2, the third finger module 10-3, and the fourth finger module 10-4 may be arranged in the second mode as illustrated in FIG. 16.

For example, when the four finger modules 10 are in the second mode, the robot hand 1 may pick up an object having a roughly circular plate shape using the finger tips 11 of the four finger modules 10. Alternatively, the robot hand 1 may grasp a spherical object using the inner links of the four finger modules 10.

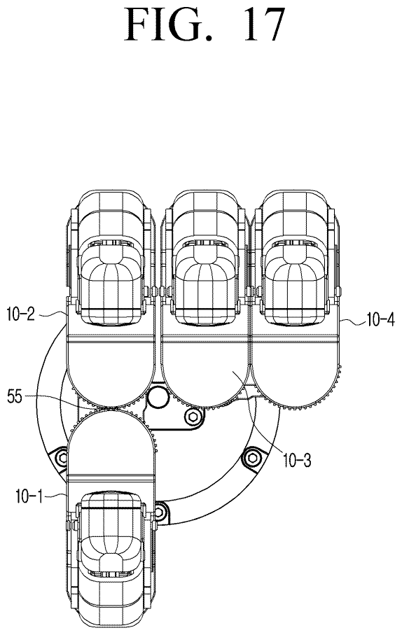

FIG. 17 is a plan view illustrating a case in which four finger modules 10 of a robot hand 1 according to one or more embodiments of the disclosure are in a third mode.

From the basic mode of FIG. 14, by operating the arrangement motor 50 of the first finger module 10-1 to rotate the first finger module 10-1 180 degrees counterclockwise, the first finger module 10-1, the second finger module 10-2, the third finger module 10-3, and the fourth finger module 10-4 may be arranged in the third mode illustrated in FIG. 17.

In the third mode, the second finger module 10-2, the third finger module 10-3, and the fourth finger module 10-4 may be arranged adjacent and parallel to each other, and the first finger module 10-1 may face the second finger module 10-2.

The first finger module 10-1 and the second finger module 10-2 are meshed with each other by the arrangement gear 55 of the housing 60, so that when the first finger module 10-1 rotates 180 degrees counterclockwise, the second finger module 10-2 may rotate 180 degrees clockwise. However, because the second finger module 10-2 is formed so that the second finger module 10-2 cannot rotate clockwise in the basic mode, the second finger module 10-2 may remain stationary, and only the first finger module 10-1 may rotate 180 degrees counterclockwise. Therefore, the angle between the first finger module 10-1 and the second finger module 10-2 may become 180 degrees, so that the first finger module 10-1 and the second finger module 10-2 may face each other.

For example, when the four finger modules 10 are in the third mode, the robot hand 1 may grasp a medium-sized part or an irregularly shaped part using the first and second inner links 21 and 22 the four finger modules 10. Alternatively, the robot hand 1 may grasp a handle of a tool using the first and second inner links 21 and 22 the four finger modules 10. Alternatively, the robot hand 1 may grasp a cylindrical object such as a bottle using the first and second inner links 21 and 22 the four finger modules 10.

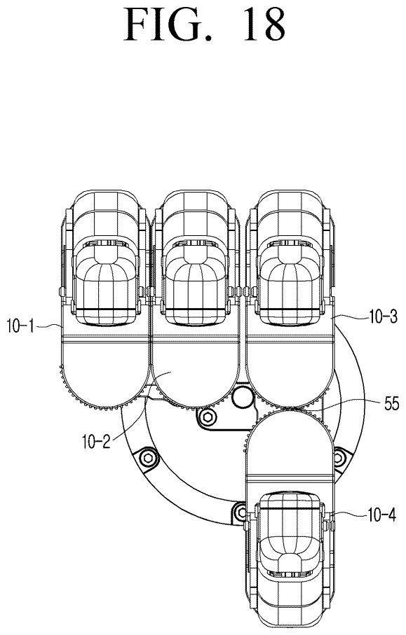

FIG. 18 is a plan view illustrating a case in which four finger modules 10 of a robot hand 1 according to one or more embodiments of the disclosure are in a fourth mode.

From the basic mode of FIG. 14, when the arrangement motor 50 of the fourth finger module 10-4 is operated to rotate the fourth finger module 10-4 180 degrees clockwise, the first finger module 10-1, the second finger module 10-2, the third finger module 10-3, and the fourth finger module 10-4 may be arranged in the fourth mode illustrated in FIG. 18.

In the fourth mode, the first finger module 10-1, the second finger module 10-2, and the third finger module 10-3 may be arranged adjacent and parallel to each other, and the fourth finger module 10-4 may face the third finger module 10-3.

The fourth finger module 10-4 and the third finger module 10-3 are meshed with each other by the arrangement gear 55 of the housing 60, so that when the fourth finger module 10-4 rotates 180 degrees clockwise, the third finger module 10-3 may rotate 180 degrees counterclockwise. However, because the third finger module 10-3 is formed so that the third finger module 10-3 cannot rotate counterclockwise in the basic mode, the third finger module 10-3 may remain stationary, and only the fourth finger module 10-4 may rotate 180 degrees clockwise. Therefore, the angle between the fourth finger module 10-4 and the third finger module 10-3 may become 180 degrees, so that the fourth finger module 10-4 and the third finger module 10-3 may face each other.

For example, when the four finger modules 10 are in the fourth mode, the robot hand 1 may grasp a medium-sized part or an irregularly shaped part using the first and second inner links 21 and 22 the four finger modules 10. Alternatively, the robot hand 1 may grasp a handle of a tool using the first and second inner links 21 and 22 the four finger modules 10. Alternatively, the robot hand 1 may grasp a cylindrical object such as a bottle using the first and second inner links 21 and 22 the four finger modules 10.

While the above describes four arrangement modes in which four finger modules 10 are arranged, the arrangement of the four finger modules 10 of the robot hand 1 according to one or more embodiments of the disclosure may not be limited thereto. The four finger modules 10 of the robot hand 1 according to one or more embodiments of the disclosure may be arranged in various ways, different from the four modes described above, depending on the shape of the object to be taken.

The robot hand 1 according to one or more embodiments of the disclosure may be configured to have various types of finger tips 11 interchangeably disposed on the tip link 27 of the finger module 10.

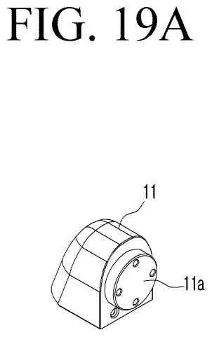

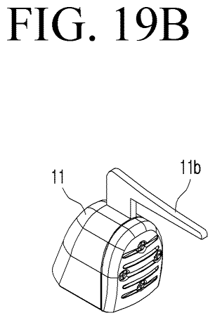

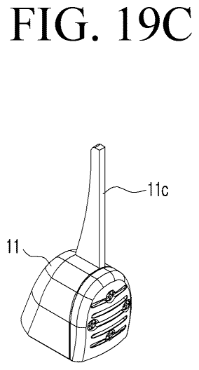

FIGS. 19A, 19B, and 19C are perspective views illustrating finger tips 11 of a robot hand 1 according to one or more embodiments of the disclosure.

As illustrated in FIG. 19A, the finger tip 11 may include a circular plate 11a disposed on the contact surface thereof. The circular plate 11a may be configured to be inserted into a circular groove formed on the surface of an object. Alternatively, the circular plate 11a may be formed of a magnet.

As illustrated in FIG. 19B, the finger tip 11 may include a hook 11b disposed at a leading end thereof. The hook 11 b may be formed to be bent at approximately 90 degrees to the contact surface of the finger tip 11. The hook 11b may be formed with a very thin thickness compared to the finger tip 11.

As illustrated in FIG. 19C, the finger tip 11 may include a rod-shaped protrusion 11c disposed at the leading end thereof. The protrusion 11c may be formed as a thin, narrow, and long rod. The length of the protrusion 11c may be formed to be longer than the length of the finger tip 11.

As described above, by installing the finger tips 11 of various shapes interchangeably at the leading end of the finger module 10, the robot hand 1 according to one or more embodiments of the disclosure may take or handle various types of objects using the finger tips 11 of appropriate shapes.

The above description describes the robot hand 1 according to one or more embodiments of the disclosure including four finger modules 10. However, the disclosure may not be limited thereto. The robot hand 1 according to one or more embodiments of the disclosure may include two or three finger modules 10.

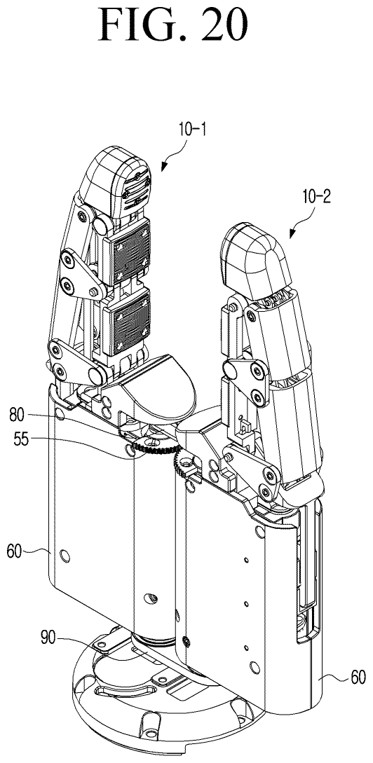

FIG. 20 is a perspective view illustrating a robot hand 1 according to one or more embodiments of the disclosure including two finger modules 10.

Referring to FIG. 20, a robot hand 1 according to one or more embodiments of the disclosure may include two finger modules 10, that is, a first finger module 10-1 and a second finger module 10-2.

The first finger module 10-1 and the second finger module 10-2 may be arranged to face each other.

For example, the first finger module 10-1 and the second finger module 10-2 may be disposed such that the arrangement gears 55 disposed in the housings 60 thereof are meshed with each other. The rotation shaft 65 of the first finger module 10-1 and the rotation shaft 65 of the second finger module 10-2 may be rotatably connected by an upper connecting link 80. The arrangement motor shaft 51 of the first finger module 10-1 and the arrangement motor shaft 51 of the second finger module 10-2 may be rotatably connected by a lower connecting link 90. The lower connecting link 90 may be fixed to the base 100.

Therefore, when the arrangement motor 50 of the first finger module 10-1 and the arrangement motor 50 of the second finger module 10-2 are operated, the first finger module 10-1 and the second finger module 10-2 may be arranged in various ways.

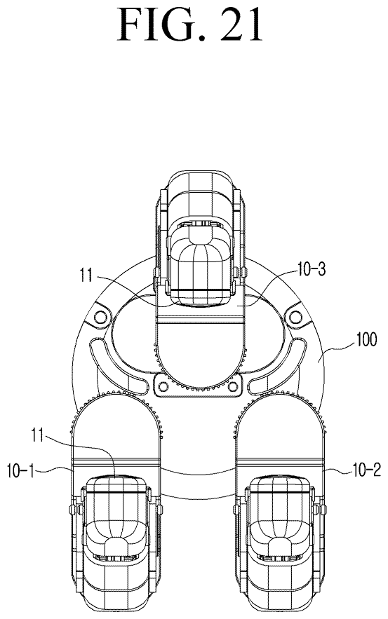

FIG. 21 is a plan view illustrating a robot hand 1 according to one or more embodiments of the disclosure including three finger modules 10.

Referring to FIG. 21, the robot hand 1 according to one or more embodiments of the disclosure may include three finger modules 10, that is, a first finger module 10-1, a second finger module 10-2, and a third finger module 10-3.

The first finger module 10-1 may be disposed to be spaced apart from the second finger module 10-2 in the horizontal direction by a certain distance. The third finger module 10-3 may be disposed to face the space between the first finger module 10-1 and the second finger module 10-2. The first finger module 10-1 and the second finger module 10-2 may be disposed so that the finger tips 11 thereof face the finger tip 11 of the third finger module 10-3. The third finger module 10-3 may be disposed so that the finger tip 11 thereof faces the finger tip 11 of the first finger module 10-1 and the finger tip 11 of the second finger module 10-2.

The first finger module 10-1, the second finger module 10-2, and the third finger module 10-3 may be disposed on the base 100. For example, the arrangement motor shaft 51 of the first finger module 10-1 may be fixed to the base 100, so that when the arrangement motor 50 of the first finger module 10-1 operates, the first finger module 10-1 may rotate with respect to the base 100. The arrangement motor shaft 51 of the second finger module 10-2 may be fixed to the base 100, so that when the arrangement motor 50 of the second finger module 10-2 operates, the second finger module 10-2 may rotate with respect to the base 100. The arrangement motor shaft 51 of the third finger module 10-3 may be fixed to the base 100, so that when the arrangement motor 50 of the third finger module 10-3 operates, the third finger module 10-3 may rotate with respect to the base 100.

Therefore, by operating the arrangement motor 50 of each of the first finger module 10-1, the second finger module 10-2, and the third finger module 10-3, the first finger module 10-1, the second finger module 10-2, and the third finger module 10-3 may be arranged in various ways.

Hereinafter, a robot including a robot hand 1 according to one or more embodiments of the disclosure will be described with reference to FIG. 22.

FIG. 22 is a block diagram illustrating a robot including robot hands 1 according to one or more embodiments of the disclosure.

Referring to FIG. 22, a robot 300 according to one or more embodiments of the disclosure may include a vision sensor 310, an image processing unit 320, a robot arm 200, a robot hand 1, a processor 330, and a memory 340.

The vision sensor 310 may be disposed in the main body of the robot 300. The vision sensor 310 may be configured to capture an object to be taken and generate an image containing the object. Various types of image sensors may be used as the vision sensor 310. For example, an RGB camera, a depth sensor, a LiDAR sensor, an infrared stereo sensor, etc. may be used as the vision sensor 310.

The image processing unit 320 may be configured to process the image captured by the vision sensor 310 to identify the type and location of the object. When there are multiple objects in the image captured by the vision sensor 310, the image processing unit 320 may segment the multiple objects and identify the type and location of each object.

For example, the image processing unit 320 may be configured to perform image classification to identify the type of object. As an example, when the object is a cup, the image processing unit 320 may perform image classification to recognize that the object is a cup.

The image processing unit 320 may be configured to perform image segmentation to identify the location and posture of the object. As an example, when the cup is standing upright, the image processing unit 320 may perform image segmentation to recognize the location of the cup and that the cup is standing upright.

The robot arm 200 may be disposed on the main body of the robot 300. The robot hand 1 may be disposed at the leading end of the robot arm 200. The robot arm 200 may position the robot hand 1 adjacent to the object so that the robot hand 1 takes the object.

The robot arm 200 may include at least one motor 201. When the robot arm 200 has multiple joints, the robot arm 200 may include multiple motors 201. When the robot arm 200 includes n joints, the robot arm 200 may include n motors 201. For example, the robot arm 200 may include #1 motor 201 to #n motor 201.

The robot arm 200 may include a driver 210. The driver 210 may be configured to control at least one motor 201. When the robot arm 200 includes multiple motors 201, the driver 210 may be configured to control the multiple motors 201. The driver 210 of the robot arm 200 may be disposed in the main body.

The robot hand 1 may be disposed at the leading end of the robot arm 200. The robot hand 1 may be disposed at the leading end of the robot arm 200 using the base 100.

The robot hand 1 may include at least two finger modules 10 and a hand processor 120.

The finger module 10 may include a finger motor 40 and an arrangement motor 50. The finger motor 40 may be configured to operate the finger 20 of the finger module 10. The arrangement motor 50 may be configured to change the arrangement of the finger module 10.

The finger module 10 may include a motor driver 110. The motor driver 110 may be configured to control the finger motor 40 and the arrangement motor 50. One motor driver 110 may be configured to control the finger motor 40 and the arrangement motor 50.

The finger module 10 may include a limit sensor 131 that limits the range of motion of the finger 20. The limit sensor 131 may be disposed within the housing 60. The limit sensor 131 may be configured to limit the movement of the moving plate 343 of the power transmission device 30. The rotational angle of the finger 20 may be limited by the limit sensor 131. The hand processor 120 may stop the finger motor 40 when a signal is input from the limit sensor 131.

The finger module 10 may include an arrangement sensor 133 that limits the rotation of the finger module 10. The arrangement sensor 133 may be disposed to limit the rotation of the finger module 10, i.e., the housing 60. The rotational angle of the finger module 10 may be limited by the arrangement sensor 133. When a signal is input from the arrangement sensor 133, the hand processor 120 may stop the arrangement motor 50.

The finger module 10 may include a finger sensor 140. The finger sensor 140 may be disposed at the leading end of the finger module 10, i.e., the finger tip 11. The finger sensor 140 may include various types of sensors, such as a force-torque sensor (FT sensor), a tactile sensor, a photo sensor, etc. The hand processor 120 may receive signals from the finger sensor 140 and control the motor driver 110.

The hand processor 120 may be configured to control at least two finger modules 10. The hand processor 120 may be configured to control the motor driver 110. In other words, the hand processor 120 may be configured to allow the at least two finger modules 10 to take an object by controlling the finger motor 40 and the arrangement motor 50 through the motor driver 110. For example, the hand processor 120 may be implemented as a microcontroller (MCU, micro control unit).

The hand processor 120 may be configured to control the motor driver 110 by receiving signals from at least one of the limit sensor 131, the arrangement sensor 133, and the finger sensor 140.

The hand processor 120 may be configured to control at least two finger modules 10 by receiving signals from the processor 330.

The robot hand 1 according to the above-described embodiment may include four finger modules 10, i.e., the first finger module 10-1, the second finger module 10-2, the third finger module 10-3, and the fourth finger module 10-4. In this case, each of the four finger modules 10 may include the finger motor 40, the arrangement motor 50, the motor driver 110 configured to control them, the limit sensor 131, the arrangement sensor 133, and the finger sensor 140.

In addition, the robot hand 1 may include the hand processor 120 configured to control four finger modules 10. The hand processor 120 may be configured to individually control the four finger modules 10. In other words, the hand processor 120 may control the location and posture of the finger module 10 by controlling the motor driver 110 using signals received from the limit sensor 131, the arrangement sensor 133, and the finger sensor 140 disposed in one finger module 10.

As another example, when the robot hand 1 according to one or more embodiments of the disclosure includes three finger modules 10, the hand processor 120 may be configured to control the three finger modules 10.

The processor 330 may be configured to control the vision sensor 310, the image processing unit 320, the robot arm 200, and the robot hand 1. The processor 330 may control the vision sensor 310 to capture an image of an object to be taken. The processor 330 may control the image processing unit 320 to process the image containing the object captured by the vision sensor 310, thereby recognizing the type, location, and posture of the object.

The processor 330 may change the arrangement of the plurality of finger modules 10 of the robot hand 1 depending on the type of object. For example, after recognizing the type of object, the processor 330 may select an appropriate arrangement mode for taking the recognized object and control the robot hand 1 to change the arrangement of the plurality of finger modules 10 of the robot hand 1. The appropriate arrangement modes of the robot hand 1 according to the type of various objects may be stored in the memory 340.

The processor 330 may transmit an electrical signal including the arrangement mode of the robot hand 1 to the hand processor 120. The hand processor 120 may arrange the plurality of finger modules 10 according to the received arrangement mode.

The processor 330 may control the robot arm 200 to position the robot hand 1 at a location where the robot hand 1 may take an object. The processor 330 may identify the location and posture of the robot hand 1 capable of taking the object through image segmentation. The processor 330 may control the driver 210 to operate at least one motor 201 of the robot arm 200, thereby positioning the robot hand 1 at a location where the robot hand 1 may take the object, and adjusting the posture of the robot hand 1 to an appropriate posture for taking the object.

The processor 330 may be configured to include, for example, a processing circuitry such as an electronic circuit board, various electronic components such as an ASIC, ROM, RAM, etc. and/or program modules.

The memory 340 may store instructions or programs for the processor 330 to process or control, as well as various data for the operation of the robot 300. For example, the memory 340 may store multiple application programs running on the robot 300, as well as data and instructions for the operation of the robot 300.

The memory 340 may be accessed by the processor 330, and data may be read/written/modify/deleted/updated by the processor 330. The memory 340 may be implemented not only as a storage medium within the robot 300, but also as an external storage medium, a removable disk including a USB memory, a web server via a network, etc.

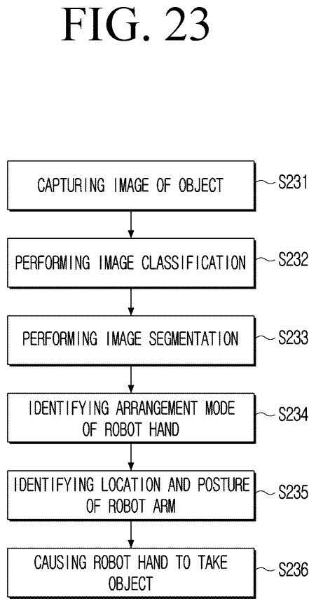

Hereinafter, a motion of a robot 300 including the robot hand 1 according to one or more embodiments of the disclosure to take an object will be described in detail with reference to FIG. 23.

FIG. 23 is a flowchart illustrating a motion of a robot including a robot hand 1 according to one or more embodiments of the disclosure to take an object.

First, the robot 300 may capture an image of an object (S231). For example, the processor 330 of the robot 300 may control the vision sensor 310 to capture an image of the object to be taken, thereby generating an image including the object.

Next, the processor 330 may perform image classification (S232). For example, the processor 330 may control the image processing unit 320 to perform image classification on the object included in the image, thereby recognizing the type of object.

Next, the processor 330 may perform image segmentation (S233). For example, the processor 330 may control the image processing unit 320 to perform image segmentation on the object, thereby recognizing the location and posture of the object.

Next, the processor 330 may identify the arrangement mode of the robot hand 1 (S234). The processor 330 may select an arrangement mode appropriate for taking the recognized object from among the plurality of arrangement modes stored in the memory 340 as the arrangement mode of the robot hand 1. For example, when the recognized object has the shape of a disk, the processor 330 may identify the arrangement mode of the robot hand 1 as the second mode. The processor 330 may transmit an electrical signal including information on the selected arrangement mode to the hand processor 120. Then, the hand processor 120 of the robot hand 1 may control the arrangement motors 50 of the four finger modules 10 according to the received signal to arrange the four finger modules 10 in the second mode.

Next, the processor 330 may identify the location and posture of the robot arm 200 (S235). For example, the processor 330 may control the plurality of motors 201 of the robot arm 200 so that the robot hand 1 disposed at the leading end of the robot arm 200 may assume an appropriate posture to take the object at a location where the object can be taken.

Finally, the processor 330 may cause the robot hand 1 to take the object (S236). For example, the processor 330 may transmit a taking signal to the hand processor 120 of the robot hand 1. Then, the hand processor 120 may control the finger motors 40 of the four finger modules 10 to take the object with the four fingers 20.

The robot hand 1 according to one or more embodiments of the disclosure having the structure as described above may appropriately arrange the plurality of finger modules 10 according to the shape of the object, thereby taking objects of various shapes.

In addition, because the passive adaptation mechanism 70 is provided in the finger 20, the robot hand 1 according to one or more embodiments of the disclosure may firmly grasp objects having a cylindrical shape or an irregular shape.

In the foregoing, the disclosure has been shown and described with reference to various embodiments. However, it is understood by those skilled in the art that various changes may be made in form and detail without departing from the scope of the disclosure as defined by the appended claims and equivalents thereof.

What is claimed is:

1. A robot hand comprising:
a plurality of finger modules; and
a connector rotatably connecting two adjacent finger modules among the plurality of finger modules,
wherein each finger module of the plurality of finger modules comprises:
a finger including a plurality of joints;
a finger motor including a finger motor shaft configured to operate movement of the finger;
an arrangement motor disposed parallel to the finger motor and including an arrangement motor shaft;
a housing disposed beneath the finger and accommodating the finger motor and the arrangement motor; and
an arrangement gear disposed concentrically with a center line of the arrangement motor shaft at an upper surface of the housing, and
wherein, for the two adjacent finger modules that are connected by the connector, the arrangement gears of each finger module mesh with each other, and based on an operation of the arrangement motor, the finger module corresponding to the operated arrangement motor rotates about the arrangement motor shaft.

2. The robot hand of claim 1, wherein
each finger module further comprises a rotation shaft protruding from the upper surface of the housing in a direction opposite to the arrangement motor shaft and aligned with the arrangement motor shaft, and
wherein the connector comprises:
an upper connecting link configured to connect and rotatably support the rotation shafts of the two adjacent finger modules;
a lower connecting link configured to connect the arrangement motor shafts of the two adjacent finger modules; and
a base configured to support the lower connecting link.

3. The robot cleaner of claim 2, wherein
the upper connecting link comprises:
two connecting holes into which each rotation shaft of the two adjacent finger modules is respectively inserted; and
bearings disposed between each connecting hole and each rotation shaft.

4. The robot hand of claim 2, wherein the lower connecting link comprises a fixed boss formed at one end thereof and a holding hole formed at another end thereof, the holding hole being rotatably disposed in a holding boss fixed to the base,
one of the arrangement motor shafts of the two adjacent finger modules is disposed in the fixed boss, and
the other of the arrangement motor shafts of the two adjacent finger modules is disposed in the holding boss.

5. The robot hand of claim 2, wherein
the connector further comprises an upper holding link that connects the rotation shaft of one of the two adjacent finger modules to a rotation shaft of another finger module among the plurality of finger modules that is not connected by the upper connecting link.

6. The robot hand of claim 2, wherein
the plurality of finger modules comprises a first finger module, a second finger module, a third finger module, and a fourth finger module, and
the upper connecting link comprises:
a first upper connecting link configured to connect the rotation shaft of the first finger module and the rotation shaft of the second finger module;
a second upper connecting link configured to connect the rotation shaft of the third finger module and the rotation shaft of the fourth finger module; and
an upper holding link disposed on an upper side of the first upper connecting link and the second upper connecting link and configured to rotatably connect one end of the first upper connecting link and one end of the second upper connecting link.

7. The robot hand of claim 2, wherein
the plurality of finger modules comprises a first finger module, a second finger module, a third finger module, and a fourth finger module, and
the lower connecting link comprises:
a first lower connecting link configured to connect the arrangement motor shaft of the first finger module and the arrangement motor shaft of the second finger module;
a second lower connecting link configured to connect the arrangement motor shaft of the third finger module and the arrangement motor shaft of the fourth finger module; and
a lower holding link disposed below the first lower connecting link and the second lower connecting link and configured to rotatably connect one end of the first lower connecting link and one end of the second lower connecting link.

8. The robot hand of claim 1, wherein
the finger comprises:
a power transmission device disposed on one side of the finger motor and including a connecting rod for transmitting power of the finger motor;
a first inner link having one end rotatably disposed on the upper surface of the housing;
a second inner link rotatably connected to another end of the first inner link;
a first outer link disposed facing the first inner link;
a second outer link disposed facing the second inner link;
a first ternary link rotatably connecting the one end of the first inner link, one end of the first outer link, and one end of the connecting rod;
a second ternary link rotatably connecting the another end of the first inner link, another end of the first outer link, and one end of the second outer link; and
a tip link rotatably connecting the second inner link and the second outer link.

9. The robot hand of claim 8, wherein
the finger further comprises a passive adaptation mechanism configured to cause the first inner link and the second inner link to apply force to an object according to a shape of the object contacting the first inner link and the second inner link.

10. The robot hand of claim 9, wherein the passive adaptation mechanism includes a plurality of passive links and a plurality of springs.

11. The robot hand of claim 10, wherein
the passive adaptation mechanism comprises:
a first passive link having one end rotatably disposed coaxially with the one end of the first inner link;
a second passive link having one end rotatably disposed coaxially with the another end of the first inner link;
a third passive link having one end rotatably disposed coaxially with another end of the second inner link;
a fourth passive link disposed between the first inner link and the first outer link and rotatably connecting another end of the first passive link and another end of the second passive link;
a fifth passive link disposed between the second inner link and the second outer link and rotatably connecting the second passive link and another end of the third passive link;
a first spring connecting the another end of the first passive link and the housing;
a second spring connecting the one end of the first inner link and one end of the second inner link; and
a third spring connecting another end of the third passive link and the tip link.

12. The robot hand of claim 8, wherein
the power transmission device comprises:
a pinion disposed on the finger motor shaft;
a transmission gear meshed with the pinion; and
a power conversion mechanism connected to the transmission gear and configured to convert rotation of the transmission gear into up-and-down movement of the connecting rod.

13. The robot hand of claim 12, wherein
the power conversion mechanism comprises:
a ball screw on which the transmission gear is disposed;
a ball nut screw connected to the ball screw;
a moving plate disposed on the ball nut and rotatably connected to another end of the connecting rod; and
a guide rail guiding linear movement of the moving plate.

14. The robot hand of claim 1, wherein
each finger module comprises a finger tip detachably disposed at a leading end of the finger.

15. The robot hand of claim 1, further comprising:
a motor driver disposed in the housing and configured to control the finger motor and the arrangement motor; and
a hand processor configured to control the motor driver.

16. The robot hand of claim 15, further comprising:
a limit sensor disposed in the housing and configured to limit a rotational angle of the finger; and
an arrangement sensor in the housing and configured to limit a rotational angle of the housing.

17. The robot hand of claim 1, wherein rotation of the arrangement gear of the finger module corresponding to the operated arrangement motor causes rotation of the arrangement gear of the finger module adjacent to the finger module corresponding to the operated arrangement motor such that the finger module adjacent to the finger module corresponding to the operated arrangement motor rotates with rotation of the finger module corresponding to the operated arrangement motor.

18. The robot hand of claim 12, wherein translational movement of the connecting rod causes rotational movement of the finger around the one end of the first inner link.

19. The robot hand of claim 7, wherein
based on an operation of the arrangement motor of the second finger module, the second finger module rotates and causes the first lower connecting link to rotate the first finger module integrally with the second finger module, and
based on an operation of the arrangement motor of the third finger module, the third finger module rotates and causes the second lower connecting link to rotate the fourth finger module integrally with the third finger module.

20. The robot hand of claim 6, wherein
based on an operation of the arrangement motor of the first finger module, the first finger module rotates and the arrangement gear of the first finger module that is meshed with the arrangement gear of the second finger module causes the second finger module to rotate, and
based on an operation of the arrangement motor of the fourth finger module, the fourth finger module rotates and the arrangement gear of the fourth finger module that is meshed with the arrangement gear of the third finger module causes the third finger module to rotate.
